(19) United States
(12) Patent Application Publication
(10) Pub. No.: US 2026/0044835 A1
(43) Pub. Date: Feb. 12, 2026

(54) RESIDENTIAL BUILDING REMAINING USEFUL LIFE DETECTOR

(71) Applicant: State Farm Mutual Automobile Insurance Company, Bloomington, IL (US)

(72) Inventor: Phillip M. Wilkowski, Gilbert, AZ (US)

(73) Assignee: State Farm Mutual Automobile Insurance Company, Bloomington, IL (US)

(21) Appl. No.: 18/918,555

(22) Filed: Oct. 17, 2024

Related U.S. Application Data
(60) Provisional application No. 63/681,032, filed on Aug. 8, 2024.
(60) Provisional application No. 63/696,726, filed on Sep. 19, 2024.

(51) Int. Cl. G06Q 10/20; G05B 23/02

(52) U.S. Cl. CPC G06Q 10/20; G05B 23/0283

(57) ABSTRACT

A system for evaluating aspects of a residential plumbing system may (1) receive, via a user device, a user input indicative of an address for the residential property; (2) communicate the address to an external database, the external database containing a plurality of residential records associated with the address in a geographic location; (3) receive, via the plurality of residential records, a plurality of plumbing system aspects and a plurality of residential property aspects; (4) predict an estimated remaining lifespan of the plumbing system based upon the plurality of plumbing system aspects and the plurality of residential property aspects; and/or (5) generate a notification, the notification comprising the estimated remaining lifespan of the plumbing system and one or more recommended actions.

### CROSS-REFERENCE TO RELATED APPLICATIONS

This application claims priority to and the benefit of U.S. Provisional Patent Application Ser. No. 63/681,032, filed Aug. 8, 2024, and U.S. Provisional Patent Application Ser. No. 63/696,726, filed Sep. 19, 2024, both of which are incorporated herein by reference in their entireties.

### FIELD OF THE INVENTION

The present disclosure generally relates to residential systems. More particularly, the present systems and methods relate to using a residential system for assessing a remaining useful life of a subsystem (or a component thereof) to allow individuals to evaluate the health of their home and/or to make modifications to their home based upon the assessments.

### BACKGROUND

Individuals may assess standard benchmarks or component characteristics when evaluating the well-being or integrity of a home or residential building. For example, an individual may assess the geographical location and/or the age of a home when evaluating the well-being and/or the remaining useful life of a system or subsystem of the home (e.g., a plumbing system, a septic system, a heating, ventilation, and air conditioning system, etc.).

However, obtaining information relevant to assessing the well-being or integrity of a home, or system/subsystem thereof, may be difficult. Further, obtaining information relevant to performing maintenance or modifications to a home, which may impact the well-being or integrity of the home or related systems/subsystems, may also be difficult. As such, conventional techniques may have certain ineffectiveness, inefficiencies, encumbrances, and/or other drawbacks when evaluating the well-being or remaining useful life of residential properties.

### BRIEF SUMMARY

A computer system may be provided that assesses a remaining useful life of a residential subsystem (or component thereof) of a residential building, such as to facilitate (i) generating a residential subsystem impact score, and/or (ii) generating a recommendation for improving the residential subsystem impact score. For instance, different types of residential data associated with a residential subsystem (e.g., a residential plumbing system, a septic system, etc.) may be analyzed (e.g., via a trained machine learning model, etc.) to generate a subsystem impact score indicating a remaining useful life of the residential subsystem and/or a component thereof. In response to generating the subsystem impact score, an action may be initiated relating to the residential subsystem (or component thereof). For example, in some instances the computer system may generate a recommendation for improving the subsystem impact score, including a recommended maintenance action, a component to add to the subsystem, a component to remove from the subsystem, and/or a component to replace in the subsystem. In some instances, the computer system may generate a user interface to be presented to the user, such as on a mobile device or other computing device, displaying the impact score to the user.

Advantageously, the example features described herein use a trained machine learning model and different types of residential data (e.g., data which is otherwise inaccessible, data which is difficult to obtain, and/or data which is not traditionally correlated and/or associated, etc.) to generate a residential impact score that indicates a remaining useful life of systems, subsystems, and/or components of a residential building. The residential impact score (e.g., remaining useful life information, etc.) may be utilized, for example, to implement a preventative and/or mitigative action (e.g., a maintenance and/or modification action, etc.) to reduce and/or prevent potential damage to components of the residential building (e.g., components of a plumbing system or subsystem, components of an associated system or subsystem, for example a refrigerator or dishwasher, etc.), thereby reducing resource consumption associated with the potential damage (e.g., water, electrical, and/or energy consumption associated with operating a damaged component, financial resources associated with repairing and/or replacing damaged components, etc.). Further, the residential impact score may be utilized, for example, to implement a preventative and/or mitigative action (e.g., a maintenance, corrective, and/or modification action, etc.) to reduce and/or prevent potential inefficient operating conditions of a component of the residential building, thereby also reducing resource consumption associated with the inefficient operating conditions (e.g., water, electrical, and/or energy consumption, etc.). In addition, the residential impact score may advantageously be utilized, for example, to implement a preventative and/or mitigative action (e.g., a maintenance and/or modification action, etc.) to reduce potential health and/or safety risks associated with a potential failure and/or potential damage to the residential building (e.g., health and/or safety risks associated with a potential flooding and/or leaking event, health and/or safety risks associated with a potentially undetectable flooding and/or leaking event, for example potential exposure to bacteria or mold, or rotting or erosive conditions in the residential building, etc.).

For example, an individual may utilize the age of their home when evaluating the remaining useful life of the home's plumbing system. However, certain components of the plumbing system may impact the life of the plumbing system more than others. For example, the characteristics (e.g., age, operating conditions, operating efficiencies, etc.) of a sump pump can significantly impact the functioning of other components of the plumbing system. Further, in some instances, the characteristics of a sump pump can potentially impact the individual and/or the home, for example by failing earlier than anticipated and/or operating at less than optimal operating conditions without the homeowner's knowledge, which can potentially lead to damage to the home (e.g., flooding of a basement, flooding of one or more portions of the home, etc.) and/or potential injury to the individual (e.g., health and/or safety issues associated with flooded areas of the home, etc.).

Advantageously, the systems and methods described herein may be used to assess (e.g., monitor, evaluate, etc.) the impact of different types of residential information (e.g., data which is otherwise inaccessible, to obtain, and/or data not traditionally correlated and/or associated, etc.) on the life of the sump pump. For example, the systems and methods described herein may assess the age of the sump pump, characteristics of the water supplied to the sump pump (e.g., mineral level, etc.), maintenance and/or repair history associated with the sump pump (e.g. when it was cleaned, when it was washed, etc.), whether the home is susceptible to freezing conditions, etc. to estimate a remaining useful life of the sump pump. Further, the systems and methods described herein may provide recommendations for preventative and/or mitigative measures (e.g., replacing the sump pump, adding a backup pump, adding a pump with advanced features such as data connectively and/or remote monitoring/alerting, etc.), thereby allowing an individual to reduce and/or prevent potential damage to their home (e.g., prevent a flooding event, etc.), inefficient operating conditions of the sump pump, and/or to reduce potential health and/or safety risks associated with a potential failure of the sump pump, as described herein.

It should be understood that while the computer system is described herein as being associated with a residential subsystem and/or a component thereof (e.g., a residential plumbing system, a septic system, a sump pump, etc.), it is contemplated that in some instances the computer system is associated with a residential complex (e.g., a residential building and a surrounding area, etc.), a residential building (e.g., a home, an apartment complex, an apartment, etc.), another residential subsystem (e.g., water heater), a component of a residential system or subsystem (e.g., toilet or dish washer), and/or a combination thereof.

In one aspect, a computer system for assessing a remaining useful life of a residential plumbing system of a residential building and/or initiating an action relating to the residential plumbing system may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to perform several operations, including (1) receiving a plurality of different types of residential data associated with the residential plumbing system; (2) determining, by processing the plurality of different types of residential data using a trained machine learning model, a residential plumbing impact score, the residential plumbing impact score indicating the remaining useful life of the residential plumbing system, where the trained machine learning model is configured to (i) estimate an impact of the plurality of different types of residential data on the remaining useful life of the residential plumbing system, and/or (ii) generate the residential plumbing impact score by predicting the remaining useful life of the residential plumbing system using the estimated impacts of the plurality of different types of residential data on the remaining useful life; and/or (3) initiating an action relating to the residential plumbing system responsive to the generation of the residential plumbing impact score. The computer system may include additional, less, or alternate functionality and/or operations, including that discussed elsewhere herein.

For instance, in certain embodiments, the functionality and/or operations may include generating a recommendation for improving the residential plumbing impact score, the recommendation including at least one of a maintenance action, a component to add to the residential plumbing system, or a component to replace in the residential plumbing system. Additionally or alternatively, the functionality and/or operations may include generating a user interface to provide the residential plumbing impact score to a user using, at least in part, fluid data indicating a mineral level of fluid provided to the residential plumbing system, an age of the residential building, an age of a component of the residential plumbing system, a material characteristic of a component of the residential plumbing system, a geographical location of the residential building, and/or other data types, including those mentioned elsewhere herein.

In some implementations, the functionality and/or operations may include (a) automatically receiving device data from a device of the residential plumbing system (such as data from device sensors, smart home sensors, or other input and/or output computing devices); and/or (b) receiving audiovisual data from a device as the device moves through the residential building (such as data from mobile device sensors, smart home sensors, AR (augmented reality) glasses, wearables, smart glasses, smart watches, VR (virtual reality) headsets, or other input and/or output computing devices).

Additionally or alternatively, the functionality and/or operations may include (1) receiving residential modification data, the residential modification data including information associated with a modification to the residential building; and/or (2) comparing the residential modification data with the action relating to the residential plumbing system to verify a recommendation for improving the residential plumbing impact score. The functionality and/or operations may include (3) generating, based upon the verification of the recommendation for improving the residential plumbing impact score, a modified residential plumbing impact score indicating an improvement in the predicted remaining useful life of the residential plumbing system; and/or (4) providing an indication of the improvement in the predicted remaining useful life of the residential plumbing system via a user interface. The functionality and/or operations may also include (5) generating, based upon the verification of the recommendation for improving the residential plumbing impact score, at least one insurance policy parameter; and/or (6) providing, presenting, or outputting the at least one insurance policy parameter to a user, such as audibly via a voice bot or chatbot, or visually or graphically via a computing device display, such as a mobile device, VR headset, AR glasses, a smart home control console or display, or other computing devices, including those mentioned elsewhere herein.

In certain implementations, the functionality and/or operations may include (1) generating at least one insurance policy parameter associated with the residential plumbing impact score, and/or (2) providing, presenting, or otherwise outputting the at least one insurance policy parameter to a user, such as audibly via a voice bot or chatbot, or visually or graphically via a computing device display, such as a mobile device, VR headset, AR glasses, a smart home control console or display, or other computing devices, including those mentioned elsewhere herein

In another aspect, a computer-implemented method for assessing a remaining useful life of at least one of a component or a subsystem of a residential building and/or initiating an action relating to the at least one component or subsystem of the residential building may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. In one instance, the computer-implemented method may include, such as via one or more local or remote processors, transceivers, sensors, other electronic components, including those discussed elsewhere herein, and/or computer-readable storage media having instructions stored thereon executable by the processors, transceivers, sensors, and/or other electronic components, (1) receiving a plurality of different types of residential data associated with the at least one of the component or the subsystem; (2) determining, by processing the plurality of different types of residential data using a trained machine learning model, a residential impact score, the residential impact score indicating the remaining useful life of the at least one of the component or the subsystem, wherein the trained machine learning model is configured to (i) estimate an impact of the plurality of different types of residential data on the remaining useful life of the at least one of the component or the subsystem, and/or (ii) generate the residential impact score by predicting the remaining useful life of the at least one of the component or the subsystem using the estimated impacts of the plurality of different types of residential data on the remaining useful life; and/or (3) initiating an action responsive to the generation of the residential impact score. The computer-implemented method may include additional, less, or alternate functionality and/or operations, including that discussed elsewhere herein.

For instance, in certain embodiments, the computer-implemented method may include, such as via one or more processors and/or other electronic components, generating a recommendation for improving the residential impact score, the recommendation including at least one of a maintenance action to perform on a plumbing subsystem of the residential building, a component to add to the plumbing subsystem, or a component to replace in the plumbing subsystem. Additionally or alternatively, the computer-implemented method may include, such as via one or more processors and/or other electronic components, generating a user interface to provide the residential impact score to a user using, at least in part, fluid data indicating a mineral level of fluid provided to the a plumbing subsystem of the residential building, an age of the residential building, an age of a component of the subsystem of the residential building, a material characteristic of a component of the subsystem, a geographical location of the residential building, and/or other data types, including those mentioned elsewhere herein.

In some implementations, the computer-implemented method may include, such as via one or more processors and/or other electronic components, (a) automatically receiving device data from a device of a residential plumbing system (such as data from device sensors, smart home sensors, or other input and/or output computing devices); and/or (b) receiving audiovisual data from a device as the device moves through the residential building (such as data from mobile device sensors, smart home sensors, AR (augmented reality) glasses, wearables, smart glasses, smart watches, VR (virtual reality) headsets, or other input and/or output computing devices).

In another aspect, a non-transitory computer readable medium having instructions stored thereon that, when executed by one or more processors, cause the one or more processors to perform various functionality and operations. For instance, the functionality and operations may include or direct (1) receiving a plurality of different types of residential data associated with a plurality of subsystems of the residential building, the plurality of subsystems including a residential plumbing system of the residential building; (2) determining, by processing the plurality of different types of residential data using a trained machine learning model, a residential impact score, the residential impact score indicating the remaining useful life of the plurality of subsystems, where the trained machine learning model is configured to (i) estimate an impact of the plurality of different types of residential data on the remaining useful life of the plurality of subsystems, and/or (ii) generate the residential impact score by predicting the remaining useful life of the plurality of subsystems using the estimated impacts of the plurality of different types of residential data on the remaining useful life; and/or (3) initiating an action responsive to the generation of the residential impact score.

For instance, in certain embodiments, the functionality and/or operations may include (1) determining, by processing the plurality of different types of residential data using the trained machine learning model, a residential plumbing impact score, the residential plumbing impact score indicating a remaining useful life of the residential plumbing system, and/or (2) generating a recommendation for improving the residential plumbing impact score.

In some implementations, the functionality and/or operations may include modifying, based upon the recommendation for improving the residential plumbing impact score, the residential impact score indicating an improvement in the predicted remaining useful life of the plurality of subsystems of the residential building.

Additionally or alternatively, the functionality and/or operations may include (1) generating, based upon a verification of the recommendation for improving the residential plumbing impact score, at least one insurance policy parameter, and/or (2) providing the at least one insurance policy parameter via a user interface.

In another aspect, a computer-implemented method for evaluating aspects of a plumbing system of a residential property. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. In one instance, the computer-implemented method may include, such as via one or more local or remote processors, transceivers, sensors, other electronic components, including those discussed elsewhere herein, and/or computer-readable storage media having instructions stored thereon executable by the processors, transceivers, sensors, and/or other electronic components, (1) receiving, via a user device, a user input indicative of an address for the residential property; (2) communicating the address to an external database, the external database containing a plurality of residential records associated with the address in a geographic location; (3) receiving, via the plurality of residential records, a plurality of plumbing system aspects and a plurality of residential property aspects; (4) predicting an estimated remaining lifespan of the plumbing system based upon the plurality of plumbing system aspects and the plurality of residential property aspects; and (5) generating a notification, the notification comprising the estimated remaining lifespan of the plumbing system and one or more recommended actions.

In some implementations, the at least one memory device is of the user device, and the computer-implemented method may include, such as via one or more processors and/or other electronic components, displaying the notification on the user device to facilitate providing estimated remaining lifespan information and the one or more recommended actions to a user. In certain implementations, the plurality of plumbing system aspects includes at least one of (i) a plumbing material, the plumbing material further comprising cast iron, cross-linked polyethylene (PEX), polyvinyl chloride (PVC), or copper; and (ii) a plumbing system age, wherein the plumbing system age is indicative of a number of years the plumbing system has been in service.

In certain implementations, the plurality of residential records associated with the address in the geographic location include temperature data for the geographic location. In certain embodiments, the plurality of residential property aspects includes (i) a city water report, the city water report indicating at least one of a potential of hydrogen (pH) level and a water hardness measure of water provided to the address; and (ii) an age of the residential property.

In some embodiments, the user input further comprises a plumbing system indication for the residential property, the plumbing system indication being indicative of (i) a water softener being present within the residential property; (ii) a water heater age of a water heater present within the residential property; or (iii) a past water claim associated with the residential property.

In some implementations, the computer-implemented method may include, such as via one or more processors and/or other electronic components, (1) generating a lifespan modification factor based upon the one or more recommended actions, wherein the lifespan modification factor is indicative of an effect the one or more recommended actions has on the estimated remaining lifespan of the plumbing system; (2) receiving an updated user input, the updated user input indicating that the one or more recommended actions has been completed by a user; (3) generating an updated remaining lifespan based upon the lifespan modification factor and the estimated remaining lifespan; (4) generating an updated notification, the updated notification comprising the updated remaining lifespan and one or more additional recommended actions; and (5) displaying the updated notification on the user device on a display of the user device.

In another aspect, a computer system for evaluating aspects of a plumbing system of a residential property. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to perform several operations, including (1) receive a user input from a user device indicative of an address for the residential property; (2) send the address to an external database, the external database containing a plurality of residential records associated with the address in a geographic location; (3) receive, the plurality of residential records, the plurality of residential records comprising a plurality of plumbing system aspects and a plurality of residential property aspects associated with the address; (4) extract the plurality of plumbing system aspects and the plurality of residential property aspects from the plurality of residential records; (5) store the plurality of plumbing system aspects and the plurality of residential property aspects in the one or more memories; (6) generate an estimated remaining lifespan of the plumbing system based upon the plurality of plumbing system aspects and the plurality of residential property aspects; and (7) generate a notification.

Additionally or alternatively, the functionality and/or operations may include transmit the notification to the user device to facilitate providing estimated remaining lifespan information and the one or more recommended actions to a user. In certain implementations, the plurality of plumbing system aspects includes at least one of (i) a plumbing material, the plumbing material further comprising cast iron, cross-linked polyethylene (PEX), polyvinyl chloride (PVC), or copper; and (ii) a plumbing system age, wherein the plumbing system age is indicative of a number of years the plumbing system has been in service.

In certain implementations, the plurality of residential records associated with the address in the geographic location include temperature data for the geographic location. In certain embodiments, the plurality of residential property aspects includes (i) a city water report, the city water report indicating at least one of a potential of hydrogen (pH) level and a water hardness measure of water provided to the address; and (ii) an age of the residential property.

In some embodiments, the user input further comprises a plumbing system indication for the residential property, the plumbing system indication being indicative of (i) a water softener being present within the residential property; (ii) a water heater age of a water heater present within the residential property; or (iii) a past water claim associated with the residential property.

In some implementations, the plumbing life detector device may be configured, such as via one or more processors and/or other electronic components, to (1) generate a lifespan modification factor based upon the one or more recommended actions, wherein the lifespan modification factor is indicative of an effect the one or more recommended actions has on the estimated remaining lifespan of the plumbing system; (2) receive an updated user input, the updated user input indicating that the one or more recommended actions has been completed by a user; (3) generate an updated remaining lifespan based upon the lifespan modification factor and the estimated remaining lifespan; (4) generate an updated notification, the updated notification comprising the updated remaining lifespan and one or more additional recommended actions; and (5) transmit the updated notification to the user device to display the updated notification on a display screen of the user device or present the updated notification via a voice bot.

In another aspect, a computer-implemented method for identifying plumbing issues of a plumbing system of a residential property. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. In one instance, the computer-implemented method may include, such as via one or more local or remote processors, transceivers, sensors, other electronic components, including those discussed elsewhere herein, and/or computer-readable storage media having instructions stored thereon executable by the processors, transceivers, sensors, and/or other electronic components, (1) receiving historical sensor data from one or more sensors, the historical sensor data comprising at least one of photo data, video data, audio data, smart home data, or mobile device data; (2) providing the historical sensor data into a machine learning model to train the machine learning model to: (i) identify a current plumbing or a current piping issue; and/or (ii) predict a future plumbing or a future piping issue; (3) receiving, via the one or more sensors, new plumbing data or new piping sensor data; (4) providing the new plumbing data or the new piping sensor data to the machine learning model; (5) identifying, via the machine learning model and the new plumbing data or the new piping sensor data, one or more current or future issues with a piping system of a building; (6) generating, based upon the one or more current or future issues, one or more corrective actions to mitigate or prevent potential damage associated with the one or more identified current or future plumbing issues; and (7) generating a message configured to be displayed, the message comprising the one or more corrective actions for at least one of one or more current plumbing issues, one or more current piping issues, one or more future plumbing issues, and/or one or more future piping issues.

In some implementations, the computer-implemented method may include, such as via one or more processors and/or other electronic components, transmitting the message to a mobile device to present the message via the mobile device, such as via a display screen of the mobile device or a voice assistant of the mobile device.

In certain embodiments, (i) a residential address or commercial address is associated with the building, (ii) the new plumbing data or the new piping sensor data is received from one or more home-mounted sensors and processors, (iii) the new plumbing data or the new piping sensor data is received in real time from the one or more sensors, and/or (iv) the one or more corrective actions comprises a mitigating action or a preventative action.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an example residential services computer system, according to some embodiments.

FIG. 2 is a block diagram of an example computer residential system, according to some embodiments.

FIG. 3 is a flow diagram of an example computer-implemented or computer-based process of initiating an action based upon an assessment of a remaining useful life of a residential plumbing system of a residential building, according to some embodiments.

FIG. 4 is a flow diagram of an illustrative example of a computer-implemented or computer-based process of initiating an action based upon an assessment of a remaining useful life of a residential plumbing system of a residential building, according to some embodiments.

FIG. 5 is a flow diagram of an illustrative example of a computer-implemented or computer-based process of providing a recommended action based upon an assessment of a remaining useful life of a plumbing system of a house, according to some embodiments.

FIG. 6 is a flow diagram of an illustrative example of a computer-implemented or computer-based process of providing a recommended actions and estimating a remaining useful life of a plumbing system of a building, according to some embodiments.

FIG. 7 is a flow diagram of an illustrative example of a computer-implemented or computer-based process of evaluating aspects of a plumbing system of a building, according to some embodiments.

FIG. 8 is a depiction of an example user interface including a recommendation to improve an estimated remaining useful life of a plumbing system of a building, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, systems, methods, and computer-readable storage media for assessing the remaining useful life of a component or subsystem of a residential building (e.g., a residential plumbing system, etc.), such as to generate a residential impact score and/or an associated recommendation for improving the residential impact score, which may be utilized, for example, to implement a preventative and/or mitigative action to reduce and/or prevent potential damage, potential inefficient operating conditions, and/or potential health and/or safety risks associated with a potential failure and/or potential damage to the residential building. For instance, different types of residential data may be analyzed (e.g., using a trained machine learning model, etc.) to estimate an impact of the different types of residential data on the remaining useful life of the subsystem (e.g., the residential plumbing system, etc.) or a component thereof, and/or generate a residential impact score that indicates (e.g., estimates, predicts, etc.) the remaining useful life of the subsystem (e.g., the residential plumbing system, etc.) or a component thereof. In response to generating the residential impact score, an action may be initiated. For example, a recommendation for improving the residential impact score may be generated and/or presented to a user, such as on a user mobile device, AR glasses, VR headset, and/or other computing device, including a recommended action (e.g., a maintenance action to perform on the residential plumbing system, a component to add to the residential plumbing system, a component to remove from the residential plumbing system, a component to replace in the residential plumbing system, and/or another suitable action).

In some instances, the residential impact score is generated and/or determined using a trained machine learning model and different types of residential data which, for example, may be difficult to obtain, otherwise inaccessible to a user, and/or not traditionally correlated and/or associated in assessing a remaining useful life of systems and/or components of a residential building. Advantageously, the residential impact score may be utilized, for example, to implement one or more preventative and/or mitigative actions (e.g., a maintenance action, a modification, a repair action, etc.). For example, the residential impact score may be utilized to implement a preventative and/or mitigative action to reduce and/or prevent potential damage to components of the residential building (e.g., components of a plumbing system or subsystem, components of an associated system or subsystem, for example a refrigerator, dishwasher, or washing machine, etc.), thereby reducing resource consumption associated with the potential damage (e.g., water, electrical, and/or energy consumption associated with operating a damaged component, etc.). The preventative and/or mitigative action may also reduce and/or prevent potential inefficient operating conditions of a component of the residential building, thereby also reducing resource consumption associated with the inefficient operating conditions (e.g., water, electrical, and/or energy consumption, etc.). Further, the residential impact score may be utilized to implement a preventative and/or mitigative action to reduce potential health and/or safety risks associated with a potential failure and/or potential damage to the residential building, for example health and/or safety risks associated with a potential flooding and/or leaking event, health and/or safety risks associated with a potentially undetectable flooding and/or leaking event (e.g., potential exposure to bacteria or mold, rotting or erosive conditions in the residential building, etc.), and/or other potential health and/or safety risks.

### OVERVIEW

Referring to the Figures, computer systems and computer-implemented methods for assessing a remaining useful life of at least one system, subsystem, and/or component of a residential building may be provided. As described herein, the computer systems and computer-implemented methods may receive different types of residential data associated with a residential building and/or system (e.g., a residential plumbing system, a septic system, etc.), which may be analyzed (e.g., via a trained machine learning model, etc.) to generate a residential impact score indicating a remaining useful life of the residential system, subsystem, and/or a component thereof. Advantageously, one aspect of the computer systems and computer-implemented methods described herein may allow individuals to utilize a residential impact score (e.g., indicating a remaining useful life of a system, subsystem, and/or component of a residential building, etc.) and/or an associated recommendation for improving the residential impact score, for example, to implement a preventative and/or mitigative action to reduce and/or prevent potential damage, potential inefficient operating conditions, and/or potential health and/or safety risks associated with a potential failure and/or potential damage to the residential building

As described herein, “remaining useful life” may be associated with a projected (e.g., estimated, predicted, determined, calculated, generated, etc.) time-period (e.g., a timeline, a period of time, etc.) for which an associated system, subsystem, component, and/or product is expected to be operable, expected to perform at predetermined conditions or at a predetermined level of performance, etc. For example, “remaining useful life” may indicate a projected time-period for which a plumbing system is expected to operate prior to a failure of one or more components. “Remaining useful life” may indicate a projected time-period for which a plumbing system is expected to operate without a potential failure. In some embodiments, “remaining useful life” indicates a projected time-period for which a system, subsystem, and/or component is expected to operate and/or perform at a predetermined level (e.g., at or above a certain efficiency level, at or below a certain resource consumption level, within a certain efficiency range, within a certain resource consumption range, etc.). In some embodiments, “remaining useful life” indicates a projected time-period for which a system, subsystem, component, and/or product associated with the system, subsystem, component, and/or product is expected to perform at predetermined conditions. For example, “remaining useful life” may indicate a projected time-period for which a dishwasher, a washing machine, a refrigerator is expected to operate (e.g., prior to failure, at a predetermined efficiency level, at a predetermined energy consumption level, etc.) based upon the operating conditions of the plumbing system.

Exemplary Residential Services System with Residential System

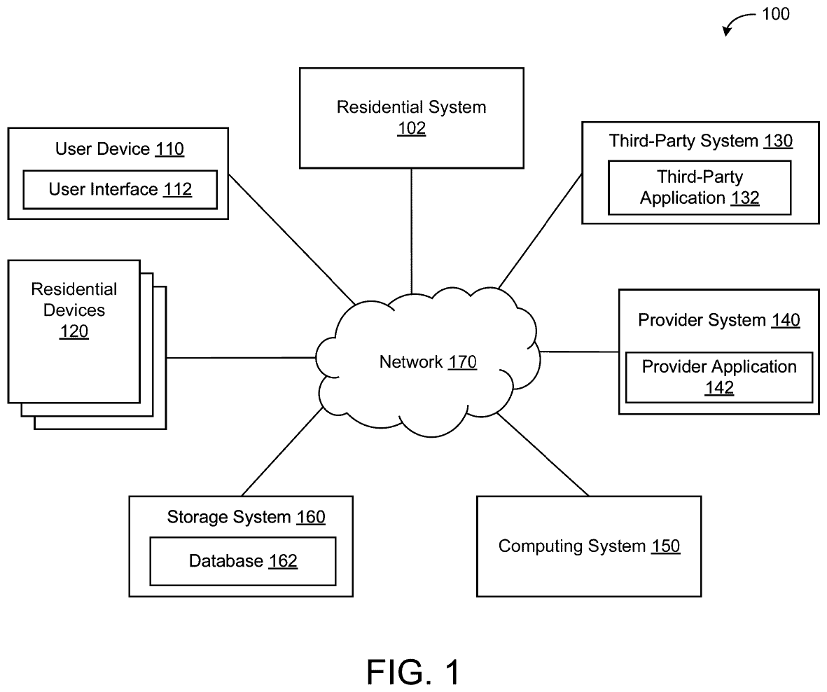

Referring to FIG. 1, a block diagram of an example residential services computer system, shown as residential services system 100, is shown, according to some embodiments. The residential services system 100 may include a computer system, shown as residential system 102, a user device 110 having a user interface 112, and at least one residential device, shown as residential devices 120. The residential services system 100 may also include a third-party system 130 having a third-party application 132, a provider system 140 having a provider application 142, and a computing system 150. The residential services system 100 may also include a storage system 160 having a database 162. The components of the residential services system 100 may be connected, or in wired or wireless communication, via a network 170. It should be noted that the number and type of components shown is merely illustrative and, in various embodiments, implementations of the residential services system 100 may have additional, fewer, and/or different components than those illustrated in FIG. 1, including those mentioned elsewhere herein.

As will be discussed in detail below, the residential system 102 may be configured to assess a remaining useful life of a system, a subsystem, and/or a component of a residential building, and/or provide (such as visually or audibly, via one or more computing devices) a residential impact score and/or a recommendation for improving the residential impact score. For example, the residential system 102 may be, or may be associated with, a residential plumbing system for assessing a remaining useful life of the residential plumbing system, or a component thereof. In some embodiments, the residential system 102 may receive a plurality of different types of residential data associated with the plumbing system, determine/generate a residential plumbing impact score indicating (e.g., predicting, estimating, etc.) the remaining useful life of the residential plumbing system, and/or initiate an action relating to the residential plumbing system using the residential plumbing impact score. In certain embodiments, initiating the action includes generating and/or providing the residential plumbing impact score to a user (e.g., visually, audibly, and/or via one or more computing devices, etc.). In other embodiments, initiating the action includes generating a recommendation for improving the residential plumbing impact score, including, for example, a recommended maintenance action, a recommended component to add/remove to/from the plumbing system, and/or a recommended component to replace in the plumbing system.

In certain implementations, a user may assess the plumbing impact score and/or the associated recommendation, for example to implement a maintenance action and/or modification (e.g., to the plumbing system or component thereof, the residential building, another system or subsystem of the building, etc.). In response to the maintenance action and/or the modification (e.g., a verification or confirmation of the maintenance action and/or modification, etc.), the residential system 102 may generate a modified residential plumbing impact score, for example indicating an improvement in the residential plumbing impact score and/or indicating (e.g., predicting, estimating, etc.) an improvement in the predicted remaining useful life of the residential plumbing system, or component thereof.

In various embodiments, the residential system 102 may receive at least one policy parameter and/or provide the at least one policy parameter to the user (e.g., visually, audibly, via one or more computing devices, etc.). As described herein, the at least one policy parameter may be associated with the residential plumbing impact score (e.g., the estimated/predicted remaining useful life of the plumbing system, or a component thereof, etc.) and/or the modified residential plumbing impact score. For example, as a benefit or reward for having a predetermined residential plumbing impact score (e.g., above a predetermined threshold, etc.), at least one policy parameter may be generated that provides a benefit to a user. Further, as a benefit or reward to implementing a maintenance action and/or modification, at least one policy parameter may be generated that provides a benefit to a user.

It should be understood that while the residential system 102 is described herein as being associated with a residential plumbing system, it is contemplated that in some embodiments the residential system 102 is associated with another system, subsystem, and/or component associated with a residential building and/or residential complex. For example, the residential system 102 may be associated with a heating, ventilation, and air conditioning (HVAC) system, an electrical system, a lighting system, a security system, and/or another suitable system, subsystem, and/or component.

Further, it should be understood that in some embodiments the residential system 102 may be associated with a residential building, residential complex, and/or a residential system (e.g., as a whole, etc.). For example, the residential system 102 may be configured to assess a remaining useful life of a residential building and/or provide (e.g., visually or audibly via one or more computing devices) a residential impact score and/or a recommendation for improving the residential impact score. As noted, in some implementations the residential system 102 may be, or may be associated with, a residential complex or system (e.g., a smart home system, a smart residential complex, a home, a building, an apartment, etc.). In certain embodiments, the residential system 102 may receive a plurality of different types of residential data associated with the residential complex and/or system, and determine/generate a residential impact score, for example indicating (e.g., predicting, estimating, etc.) the remaining useful life of the residential complex and/or system (or a component thereof).

In various embodiments, the different types of residential data are associated with one or more systems, subsystems, and/or components associated with the residential complex and/or system. For example, the residential data may include data associated with a residential plumbing system (e.g., as described herein), an HVAC system (e.g., materials or devices used, history of repairs or maintenance, usage and/or power consumption, etc.), an electrical system (e.g., materials or devices used, history of repairs or maintenance, usage and/or power consumption, etc.), a lighting system (e.g., materials or devices used, history of repairs or maintenance, usage and/or power consumption, etc.), a security system (e.g., history of repairs or maintenance, usage, presence of monitoring capabilities, etc.), and/or another suitable system associated with the residential complex.

In some embodiments, the residential data includes data associated with an environment of the building complex (e.g., data relating to weather, temperature, hazards, seasonal hazards and/or changes, local fauna, local flora, air quality, pollen, landscape, bodies of water, and/or any other such suitable environmental hazards and/or benefits, etc.), data associated with a location of the building complex (e.g., data relating to a local population density, a local classification, for example urban, rural, suburban, city, town, village, etc., proximity to a highway, proximity to public transportation, proximity to various businesses, proximity to neighbors, proximity to schools, crime rates, and/or any other suitable location-based hazards and/or benefits, etc.), and/or emergency response related data or information associated with the building complex (e.g., data relating to a proximity to a hospital, proximity to a fire station, proximity to a police station, presence of nearby fire hydrants, ease of ambulance access, crime response rate, crime response time and/or speed, and/or any other such suitable emergency-related hazards and/or benefits, etc.).

In certain implementations, the residential data includes data associated with construction-related events of the building complex (e.g., data relating to building adherence to construction codes, adherence to construction best practices, building materials used, structural stability, architectural design, building age, history of replacements and/or repairs, appliances, smart devices, plumbing, water consumption, power consumption, wiring, security, and/or any other such suitable construction-related hazards and/or benefits, etc.), data associated with occupancy and/or usage of the building complex (e.g., usage patterns, times or days of usage and/or occupancy, times or days of operation, etc.), and/or data associated with other risks or hazards associated with the building complex (e.g., crime rates in the surrounding location, occurrences of hazardous or damaging events, occurrences and/or severity of claims associated with the building and/or the surrounding area, etc.).

As indicated, the residential system 102 may receive the plurality of different types of residential data associated with the residential complex and/or system, and determine/generate a residential impact score, for example indicating (e.g., predicting, estimating, etc.) the remaining useful life of the residential complex and/or system (or a component thereof). The residential system 102 may further initiate an action relating to the residential complex and/or system using the residential impact score. For example, the residential system 102 may generate and/or provide the residential impact score to a user (e.g., visually, audibly, and/or via one or more computing devices, etc.). The residential system 102 may also generate a recommendation for improving the residential impact score, including, for example, a recommended action (e.g., a maintenance action, a recommended modification to the building complex, etc.).

In some embodiments, a user may assess the residential impact score and/or the associated recommendation, for example to implement a maintenance action and/or medication. In response to the maintenance action and/or the modification (e.g., a verification or confirmation of the maintenance action and/or modification, etc.) the residential system 102 may generate and/or provide a modified residential impact score (e.g., indicating an improvement in the residential impact score and/or an improvement in the predicted remaining useful life of the residential complex or system, etc.). In some implementations, the residential system 102 may generate and/or provide at least one policy parameter. For example, in response to determining a residential impact score having a predetermined value (e.g., above a predetermined threshold, within a predetermined range, etc.), the residential system 102 may generate at least one policy parameter that provides a benefit (e.g., a discount, a reward, a cost-savings, a cost reduction, an increase or expansion in coverage, an increase in duration of coverage of a policy, etc.). Further, as a benefit or reward to implementing a maintenance action and/or modification, the residential system 102 may generate at least one policy parameter that provides a benefit, as described herein.

It should be understood that it is contemplated that the residential system 102 described herein may be configured to receive (e.g., obtain, accept, get, request, retrieve, pull, etc.) any and/or all of the different types of types of residential data described herein. For example, the residential system 102 may be, or may be associated with, a residential plumbing system, and may be configured to receive different types of residential data associated with a system, subsystem, and/or component of a residential building, and/or different types of residential data associated with a building complex and/or building system. In various embodiments, the residential system 102 may be, or may be associated with, a residential plumbing system, and may be configured to receive different types of residential data associated with a residential building, including data associated with other subsystems of the residential building (e.g., an HVAC system, an electrical system, a lighting system, etc.), environmental data associated with the residential building, location-related information associated with the building, construction-related data associated with the residential building, and/or any other suitable residential data described herein. In this regard, the residential system 102 may be configured to receive various different types of data associated with (e.g., related to, connected to, correlated with, linked to, etc.) with a residential building and/or the associated area or location.

Referring back to FIG. 1, according to certain embodiments, components of the residential services system 100 may be configured to communicate (e.g., via the network 170). For example, components of the residential services system 100 may be configured to communicate with the residential system 102. Information and/or data associated with the user device 110 and/or the residential devices 120 may be communicated to the residential system 102 (e.g., via the network 170). Information and/or data associated with the third-party system 130 and/or the provider system 140 may also be communicated to the residential system 102 (e.g., via the network 170). Information and/or data associated with the computing system 150 and/or the storage system 160 may also be communicated to the residential system 102 (e.g., via the network 170).

In some embodiments, the residential system 102 may be implemented using cloud computing services. The residential system 102 may be implemented using one or more computing devices, for example operating alone and/or in combination. In some embodiments, the residential system 102 may be implemented using computing architectures like multiple distributed servers, and/or similar computing devices and/or systems. In some implementations, the residential system 102 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the residential system 102 may be configured to communicate with the user device 110. The user device 110 may include one or more human-machine interfaces or client interfaces, shown as user interface 112 (e.g., a graphical user interface, a text-based computer interface, a client-facing web service, a web service that provides pages to a web client, etc.), for example for controlling, viewing, and/or otherwise interfacing with the residential system 102. The user device 110 may include a personal mobile computing device (e.g., a smart phone, a tablet, a mobile device, a wearable, smart glasses, a smart watch, etc.). The user device 110 may include a computer workstation, a client terminal, a remote or local interface, and/or any other user interface device. The user device 110 may be a stationary terminal (e.g., a desktop computer, a laptop computer, a tablet, or another suitable non-mobile device).

In various embodiments, information/data associated with the user device 110 may be communicated to the residential system 102. In certain implementations, the user device 110 itself may be configured to communicate information/data to the residential system 102. In certain embodiments, a device coupled to the user device 110, a component implemented with the user device 110, an application or program housed and/or executed on the user device 110, and/or another suitable component associated with the user device 110 may be configured to communicate information/data to the residential system 102.

In some embodiments, the residential system 102 may be configured to receive a request (e.g., associated with the user device 110). For example, the user device 110 (e.g., in response to an input from a user or operator, etc.) may communicate a request to the residential system 102. It should be understood that while the residential system 102 is described herein as receiving a request associated with the user device 110, it is contemplated that the residential system 102 may receive a request associated with any and/or all of the components of the residential services system 100 (e.g., the third-party system 130, the provider system 140, the computing system 150, etc.).

The request may identify a residential system, subsystem, and/or component a user or operator desires to know information about (e.g., a remaining useful life, a well-being, an integrity, etc.). For example, the request may identify a plumbing system of a residence, a section of piping within a residence, and/or a plumbing fixture (e.g., a toilet, a sink, etc.) that a user desires to know information about (e.g., an estimated or projected remaining useful life, etc.). The request may also identify an attribute, characteristic, criteria, and/or quality which, for example, a user or operator desires to know information about. For example, the request may identify a fluid characteristic (e.g., mineral content, fluid flow characteristics, fluid usage, etc.) and/or a residential system or component (e.g., a plumbing system, a plumbing fixture, etc.), which a user or operator desires to know information about (e.g., how the identified fluid characteristic affects the remaining useful life, well-being, and/or integrity of the system or component, etc.).

In some embodiments, the request may identify a plurality of systems, subsystems, and/or components. Further, the request may identify a plurality of attributes, characteristics, criteria, and/or qualities, for which a user or operator desires to know information about. For example, the request may identify a first fluid characteristic (e.g., a mineral content, etc.) and/or a second fluid characteristic (e.g., a fluid pressure, etc.), as well as a system associated with a residence (e.g., a plumbing system, etc.) and a subsection of the system (e.g., a section of piping in the basement, etc.), for which the user or operator desires to know how the identified characteristics affect the system and subsystem (e.g., how the mineral content and the fluid pressure affect the remaining useful life of the residential plumbing system, and specifically the section of piping in the basement, etc.).

In various embodiments, the request may also include additional information (e.g., a time or time-period associated with the request, a device identifier associated with a device that initiates and/or communicates the request, an application/user identifier associated with a user or operator of an application that initiates and/or communicates the request, etc.). In some embodiments, the request may also include a preference. For example, the request may include a feedback preference (e.g., a preference to receive feedback in the form of generating, modifying, updating, and/or altering a residential impact score and/or a residential profile; a preference to receive feedback in the form of a maintenance recommendation; a preference to receive feedback in the form of a recommended action for improving a residential impact score and/or a residential profile, etc.).

The residential system 102 may also be configured to receive information/data associated with the user device 110. For example, the user device 110 may (e.g., automatically, or in response to an input from a user or operator, etc.) communicate geolocation and/or residential telematics data associated with the user device 110 to the residential system. For example, the user device 110 may communicate information associated with a location of the user device 110, a pattern of movement of the user device 110 within and/or outside a residence, and/or other similar geolocation and/or telematics data. The user or operator may opt-in to sharing geolocation and/or telematics data with the residential system 102 (e.g., at predetermined times, in predetermined locations, during use of predetermined applications or services, etc.), and/or the user device 110 may communicate real-time and/or historic geolocation and/or telematics data associated with the user device 110 to the residential system 102.

The residential system 102 may also be configured to receive data and/or information gathered and/or captured by the user device 110. For example, the user device 110 may include a microphone or camera (e.g., for capturing audiovisual information, etc.). The user device 110 may capture (e.g., automatically, and/or in response to an input by a user or operator) audiovisual data around the user device 110, for example while a user or operator is within or moving within the residence. In some implementations, the user device 110 may be configured to capture audiovisual data around the user device 110 (e.g., a video, images, etc.), for example to communicate a layout, a floorplan, and/or a location and/or position of components or devices associated with a residence to the residential system 102. In certain embodiments, the user device 110 may be configured to communicate audiovisual information (e.g., voice memos, voicemails, images, videos, etc.) stored on the user device 110 to the residential system 102.

The residential system 102 may also be configured to receive information/data associated with a user or operator associated with the user device 110. For example, the user device 110 may (e.g., automatically, or in response to an input from a user or operator, etc.) be configured to communicate information associated with one or more applications (e.g., housed or executed on the user device 110) to the residential system 102. In certain implementations, the user device 110 may communicate residential and/or maintenance information associated with a user or operator (e.g., a residence or residential building associated with the user or operator, etc.), for example from a bill pay or utilities application (e.g., associated with a utilities provider, etc.), a maintenance or residential care application, and/or similar applications. For example, the user device 110 may communicate information about an amount of water or energy consumption (e.g., via a bill pay or utilities application, etc.), a history or log of recent repairs and/or maintenance performed at the residence (e.g., recent repairs performed on a water softener of a plumbing system, recent routine maintenance to a septic system, etc., for example via a maintenance application, etc.), and/or other similar information or data.

The residential system 102 may also be configured to receive information associated with a product or service associated with a user or operator of the user device 110. For example, the user device 110 may (e.g., automatically, or in response to an input from a user or operator) communicate information associated with a residential building or residence associated with the user or operator (e.g., a home, apartment, building, etc.). In various embodiments, the user device 110 (e.g., via an application, a website, one or more interfaces, etc.) is configured to prompt a user or operator (e.g., automatically, or in response to an input from the user or operator) for information associated with a product or service associated with the user or operator of the user device 110. For example, the user device 110 may prompt a user or operator (e.g., via a quiz, a questionnaire, a survey, a feedback form, etc.) for information associated with a residential building or residence of the user or operator, and the information may be communicated to the residential system 102.

In some embodiments, the information associated with the product or service (e.g., the residential building, residence, etc.) may include a geolocation of a residence (e.g., an address, town, city, county, etc.), a size of the property, and/or a year the residence was built. In some embodiments, the information may include environmental-related information associated with the residence (e.g., proximity to a body of water, seasonal hazards, average and/or amount of seasonal rainfall, etc.). The information may also include construction-related information, for example a builder of the residence, a material provider, a building timeline, materials used to build the residence, a floorplan associated with the residence (e.g., square footage, number of floors, number of rooms, number of bathrooms, etc.), and/or any other suitable construction-related information (e.g., adherence to construction best practices, structural stability, architectural design, etc.).

In certain implementations, the information associated with the product or service (e.g., the residential building, residence, etc.) includes system and/or subsystem-related information associated with the residence. For example, the information may include information associated with a plumbing system of the residence, such as whether there is a water softener and/or water heater, whether the system is connected to public water or septic sources, whether the water source is a well or public utilities, etc. The information may also include information about components of the system and/or subsystem. For example, the information may include characteristics associated with sinks, toilets, showers, dishwashers, washing machines, refrigerators, and/or other suitable appliances or devices (e.g., year, make, model, type, quality, smart-functioning capabilities, automated or sensor functionalities, etc.). Further, the information may include characteristics associated with the materials used in the systems and/or subsystems (e.g., metal, plastic, cast iron, cross-linked polyethylene (PEX), polyvinyl chloride (PVC), copper, etc.), and/or other suitable information or data.

In certain embodiments, the information associated with the product or service (e.g., the residential building, residence, etc.) includes information associated with maintenance, repair, and/or residential care associated with systems, subsystems, and/or components of the residence, as described herein. For example, the information may include a history of repairs and/or maintenance performed on the plumbing system of the residence, a history of claims and/or requests associated with a component or device of the plumbing system of the residence (e.g., a request to replace a toilet that overflows, an overflowing septic system, etc.), and/or other suitable information or data. In various embodiments, the information associated with the product or service (e.g., the residential building, residence, etc.) also includes information associated with a surrounding of the residence. For example, the information may include information on the presence of recreational products (e.g., a pool, hot tub, outdoor shower system, etc.), home care products (e.g., a sprinkler system, etc.), and/or other suitable information. Further, the information may include characteristics of a neighborhood or area surrounding the residence (e.g., year, make, model, builder/material provider, etc. of houses in the surrounding neighborhood, connections to public or private utilities or service providers, etc.), and/or any other suitable information.

As shown, information/data associated with the residential devices 120 may also be communicated to the residential system 102. In some implementations, the residential devices 120 may be configured to communicate information/data to the residential system 102 (e.g., automatically, in response to a query, in response to an instruction, etc.). In some embodiments, a device coupled to, a system or device monitoring a residential device, a device obtaining data from and/or regarding a device, and/or another suitable system or device associated with a residential device may be configured to communicate information/data to the residential system 102.

In some embodiments, the residential devices 120 may be associated with a residential building, a residential complex, and/or a residential system. For example, the residential devices 120 may be associated with a residence (e.g., a home, an apartment, a condominium, etc.) of a user or operator. In some embodiments, the residential devices 120 may be associated with a residential system (e.g., a smart home system, etc.). For example, the residential devices 120 may be a set or group of devices that form a residential system (e.g., a smart home system, a smart residential plumbing system, etc.)

In various embodiments, the residential devices 120 may be associated with a system and/or a subsystem of a residential building, a residential complex, and/or a residential system. For example, the residential devices 120 may be associated with a residential plumbing system of a residential building. It should be understood that while the residential devices 120 are described herein as being associated with a residential plumbing system, it is contemplated that in some instances the residential devices 120 are associated with additional and/or different systems and/or subsystems (e.g., an HVAC system, an electrical system, a lighting system, a security system, and/or another suitable home and/or residential system and/or subsystem, etc.).

The residential device 120 may include a toilet, a bidet, a sink, a bathtub fixture, a showerhead, and/or another suitable plumbing fixture. The residential device 120 may also include a water heater, a water softener, a water filtration system, and/or another suitable fluid control device. In certain embodiments, the residential device 120 may include a dishwasher, a washing machine, a refrigerator, an ice maker, an ice dispenser, a freezer, and/or another suitable residential device that utilizes water and/or a fluid. Further, the residential device 120 may also include additional components or devices that utilize water and/or fluid (e.g., a sprinkler head, a spicket, a drainage spout, etc.).

The residential device 120 may also include one or more components or devices coupled with a residential device, as described herein. For example, the residential device 120 may be or include a sensor (e.g., a flow sensor, a pressure sensor, a temperature sensor, etc.), a control valve (e.g., a pressure valve, a backflow valve, etc.), and/or other suitable components, for example to capture plumbing-related home telematics data (e.g., fluid pressure data, fluid flow data, fluid characteristics information, for example mineral level, pH level, contaminant level, sediment level, etc.). The residential device 120 may also be or include components or materials associated with a residential system or subsystem. For example, the residential device 120 may be a component and/or material of the residential plumbing system (e.g., a pipe, a valve, a conduit, a pipe fitting, a drain, a trap, a faucet, an inlet line, an outlet line, a hot water line, a cold water line, a vent line, a waste line, a p-trap, a soil stack, a soil line, etc.), and/or another suitable component and/or material.

In some embodiments, the residential system 102 may be configured to receive residential device information/data associated with the residential device 120. The residential system 102 may receive device information/data associated with the residential device 120 automatically, or in response to an input (e.g., a request, a call, etc.). For example, the residential system 102 may receive device related metrics associated with the residential device 120 (e.g., year, make, model, type, quality, smart-functioning capabilities, automated or sensor functionalities, etc.). The residential system 102 may receive operational characteristics associated with the operation of the residential device 120 (e.g., fluid or water pressure, fluid or water flow rate, fluid or water drainage, etc.). In some implementations, the residential system 102 may receive fluid characteristics associated with fluid used by the residential device 120 (e.g., a mineral level, a pH level, a contaminant level, a sediment level, etc.).

In certain implementations, the residential system 102 may be configured to receive historic device related information associated with the residential device 120. For example, the residential system 102 may receive information relating to historic operational characteristics and/or fluid characteristics associated with fluid used by the residential device 120. In various embodiments, the residential system 102 may be configured to receive notifications from the residential device 120. For example, the residential system 102 may be configured to receive an alert, alarm, or a warning notification from the residential device (e.g., when an operational characteristic exceeds or falls below a threshold, when an operational characteristic moves outside a predetermined range, when a fluid characteristic exceeds a threshold or falls below a threshold, etc.).

As described herein, in some embodiments the device related information/data may be used to assess and/or analyze a remaining useful life of a residential system, subsystem, and/or a component thereof. For example, the device related information/data may be used (e.g., in part) to assess a remaining useful life of a residential plumbing system of a residence. Further, the device related information/data may be used (e.g., in part) to assess a remaining useful life of a water softener system (e.g., a subsystem, etc.) and/or a toilet in the basement (e.g., a component, etc.).

As shown, the residential system 102 may be configured to receive information/data associated with the third-party system 130. The third-party system 130 may include a third-party application 132. While the residential services system 100 is shown to include one third-party system 130, it is contemplated herein that the residential services system 100 may include a plurality of third-party systems 130. In certain embodiments, the residential system 102 may be configured to receive residential information/data associated with the third-party system 130. For example, the residential system 102 may be configured to receive residential data, as described herein, from and/or associated with the third-party system 130.

In some embodiments, the third-party system 130 may be associated with a public entity. For example, the third-party system 130 may be associated with a city, a town, a village, a municipality, and/or another suitable government entity. The residential system 102 may be configured to receive (e.g., automatically, and/or in response to an input from a user or operator) map and/or land information associated with the third-party system 130. For example, the residential system 102 may receive map and/or land plot information, including addresses, lot diagrams, water systems, water lines, septic systems, septic lines, well location, electric power lines, telephone lines, and/or other suitable map and/or land plot information (e.g., topographic, roads, streets, alleyways, etc.).

In some embodiments, the third-party system 130 may be associated with a public utility entity. For example, the third-party system 130 may be associated with a water utility entity. The residential system 102 may be configured to receive residential information associated with the third-party system 130. For example, the residential system 102 may be configured to receive reports, studies, test results, etc. associated with the third-party system 130 (e.g., a water utility entity, etc.), including, for example, water quality information, water characteristic data (e.g., mineral level, pH level, pH level, contaminant levels, sediment level, microbial levels, nitrate levels, lead levels, copper levels, etc.), water supply information, water treatment information, and/or other water-related information and data. In various embodiments, the third-party system 130 is associated with additional and/or different public utility entities (e.g., gas, electricity, telephone, waste disposal, communications systems, etc.), and the residential system 102 may be configured to receive information (e.g., reports, studies, test results, etc.) associated with the additional public utilities.

In certain implementations, the third-party system 130 is associated with a private utility entity. For example, the third-party system 130 may be associated with a private water utility entity. The residential system 102 may be configured to receive information associated with the third-party system 130 (e.g., the private water utility entity, etc.), including, for example, water quality information, water characteristic data (e.g., mineral level, pH level, pH level, contaminant level, sediment level, etc.), water supply information, water treatment information, and/or other water-related information and data.

In some implementations, the residential system 102 may be configured to receive historic residential data (e.g., from a public utility entity, a private utility entity, etc.). For example, the residential system 102 may receive historic information relating to water quality information, water characteristic data (e.g., mineral level, pH level, pH level, contaminant level, sediment level, etc.), water supply information, water treatment information, and/or other water-related information and data.

As shown, information/data associated with the provider system 140 may be communicated to the residential system 102. In certain embodiments, the provider system 140 may be configured to communicate information/data to the residential system 102. In some embodiments, a device coupled to, a component implemented with the provider system 140, an application or program housed and/or executed on the provider system 140, and/or another suitable component associated with the provider system 140 may be configured to communicate information/data to the residential system 102.

The provider system 140 may include a provider application 142. In various embodiments, the provider system 140 may be associated with a company or entity that provides protective services (e.g., insurance, etc.) to a user or operator (e.g., a user or operator associated with the user device 110), a company or service provider (e.g., a provider associated with the third-party system 130), and/or over one or more products or services (e.g., associated with the residential device 120, etc.). In some embodiments, the provider system 140 may include the residential system 102, as described herein. The provider system 140 may be configured to communicate with the residential system 102 (and/or the user device 110), for example to initiate an action related to a residential building (e.g., a residential plumbing system) and/or to provide one or more policy parameters, as described herein.

In some embodiments, the residential system 102 may be configured to receive a policy parameter. The provider system 140 may be configured to provide a policy parameter (e.g., to the residential system 102, to the user device 110, to other components of the residential services system 100, etc.). A policy parameter may refer to a parameter of one or more insurance products (e.g., coverages, policy terms, premiums, etc.). In certain embodiments, the policy parameter may be selected, generated, and/or offered, for example to provide coverage, supplement and/or increase existing coverage, and/or to provide new coverage. In certain implementations, the provider system 140 may be configured to generate a plurality of policy parameters. For example, the provider system 140 may be configured to generate a plurality of policy parameters associated with a residential impact score, a modified residential impact score, and/or a recommendation associated with a residential impact score, as will be described herein.

In various embodiments, the policy parameters may be selected, generated, and/or offered based upon a policy availability and/or a policy source, a policy availability location, and/or additional parameters (e.g., a cost, a time over which the policy is available, a product or service over which the policy is available, a location over which the policy is available, eligibility requirements, ability to group or bundle different policies or parameters, available discounts or rewards associated with a policy or parameter, etc.).

As noted herein, in certain embodiments the residential system 102 may be configured to receive one or more policy parameters associated with a residential impact score (e.g., a residential plumbing impact score, a modified residential impact score, etc.). For example, a policy may be generated (e.g., via the provider system 140) that provides coverage over a residential building and/or the systems, subsystems, and/or components therein. In various embodiments, as a benefit or reward for having a predetermined residential impact score (e.g., a residential plumbing impact score above a predetermined threshold, within a predetermined range, etc.), at least one policy parameter may be generated that provides a benefit to a user (e.g., an insurance policy, a discount, a reward, a cost-savings, a cost reduction to an existing policy, an increase in coverage, an increase in duration of coverage of a policy, etc.). Similarly, as a benefit or reward for improving a residential impact score (e.g., an improvement in a residential plumbing impact score via a maintenance action, a modification, etc.), at least one policy parameter may be generated that provides a benefit to a user.

In addition, and as noted herein, in some implementations the residential system 102 may be configured to receive one or more policy parameters associated with a recommendation (e.g., a recommendation for improving a residential impact score, a residential plumbing impact score, etc.). For example, as a benefit or reward for implementing a maintenance action and/or modification (e.g., and/or an associated modified residential impact score, etc.), at least one policy parameter may be generated that provides a benefit to a user.

In some embodiments, the one or more policy parameters may also be generated using one or more factors associated with a residential building, a system, a subsystem, and/or a component thereof. For example, one or more policy parameters may be generated using a base policy (e.g., cost, rate, coverage, etc.), a location rating factor (e.g., neighborhood, city, state, urban location, rural location, etc.), a coverage rating (e.g., availability, amount, term, etc. of coverage), a claim rating factor (e.g., based upon historical claim information associated with the residential building, similarly situated residential buildings in the neighborhood or city, similarly situated residential buildings built by the same builder or contractor, similarly situated buildings connected to the same utility provider, etc.), a maintenance and/or residential care discount (e.g., a routine maintenance discount, a timely repair discount, etc.), a resource efficiency discount (e.g., a use of resource and/or energy efficient components and/or devices associated with the residential building, etc.), a safety impact discount, a risk rating (e.g., a personal injury risk rating, a liability risk rating, etc. associated with a residential building, etc.), and/or a combination thereof. The one or more policy parameters may be selected and/or generated, for example to provide a benefit or reward to a user associated with the residential building, systems, subsystems, and/or components thereof.

In some embodiments, the policy parameter may be associated with various forms of coverage of an individual, for example comprehensive coverage, liability coverage, rental coverage, uninsured and/or underinsured coverage, medical payments coverage, emergency assistance coverage, personal injury coverage, incidental injury coverage, and/or other suitable residential related coverages.

As shown, the residential system 102 may be configured to communicate with the computing system 150. In some embodiments, the computing system 150 may be a cloud-based computing system, for example to provide digital connections between different computing devices and/or systems (e.g., as described herein). The computing system 150 may be a virtual reality (VR) system or augmented reality (AR) system, for example to provide digital connections between a plurality of metadata sources, where the metadata sources are integrated within the VR system or AR system.

In various embodiments, the computing system 150 may be implemented using one or more computing devices, for example operating alone and/or in combination. In various embodiments, the computing system 150 may be implemented using computing architectures like multiple distributed servers, and/or similar computing devices and/or systems. In certain embodiments, the computing system 150 may be a server (e.g., including a processor coupled to a memory), for example to store and/or recall data and applications within the memory. In some embodiments, the computing system 150 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the residential system 102 may be configured to communicate with the storage system 160 (e.g., having the database 162). In some implementations, the residential system 102 communicates with the storage system 160, either directly (e.g., via the network 170) or indirectly (e.g., via the user device 110, the residential devices 120, etc.). The storage system 160 may include one or more devices (e.g., RAM, ROM, Flash memory, hard disk storage, etc.) for storing data and/or computer code for implementing and/or facilitating the various processes, layers, and/or circuits described herein. The storage system 160 may be or include volatile memory or non-volatile memory, and may include database components, object code components, script components, and/or any other type of information structure for supporting the various activities and information structures described herein.

It should be understood that in some implementations the components of the residential services system 100 may be configured to perform (e.g., implement, etc.) fewer, additional, and/or different functions. For example, one or more components of the residential services system 100 (e.g., the user device 110, the residential device 120, the third-party system 130, etc.) may be configured to implement (e.g., execute, perform, etc.) any and/or all of the functionalities and/or features described herein (e.g., any and/or all of the functionalities and/or features of the residential system 102, the user device 110, the residential devices 120, the third-party system 130, the provider system 140, the computing system 150, and/or the storage system 160, etc.). For example, the user device 110 may be configured to house and/or store one of more component (e.g., an application, etc.), for example to facilitate executing one or more of the functionalities and/or features described herein (e.g., one or more features and/or functionalities of the residential system 120, etc.).

In certain embodiments, and as will be discussed in greater detail, the residential system 102 may also be configured to generate data. For example, the residential system 102 may include components (e.g., a compiler, a residential data analyzer, a trained machine learning model to implement functions of an impact analyzer and/or a score generator, an action generator, and a database) that obtain, analyze, process, generate, store, and/or communicate data.

In various embodiments, the residential system 102 may be configured to initiate one or more actions relating to a residential system. For example, the residential system 102 may (i) receive a plurality of different types of residential data (e.g., residential data associated with a residential plumbing system, etc.); (ii) determine, by processing the different types of residential data using a trained machine learning model, a residential impact score (e.g., a residential plumbing impact score, etc.), where the residential impact score indicates a remaining useful life of the residential system and/or a component thereof (e.g., the residential plumbing system and/or a component thereof, etc.), and where the trained machine learning model is configured to (iii) estimate an impact of the plurality of different types of residential data on the remaining useful life of the residential system (e.g., the residential plumbing system, etc.), and/or (iv) generate the residential impact score by predicting the remaining useful life of the residential system using the estimated impacts of the plurality of different types of residential data on the remaining useful life; and/or (v) initiate an action relating to the residential system (e.g., the residential plumbing system, etc.) responsive to the generation of the residential impact score (e.g., the residential plumbing impact score, etc.), where initiating the action may include (vi) generating a user interface to provide the residential impact score to a user and/or (vii) generating a recommendation for improving the residential impact score, for example a recommended maintenance action, a component to add to/remove from the residential system, and/or a component to replace in the residential system.

### Exemplary Residential Building Assessment System

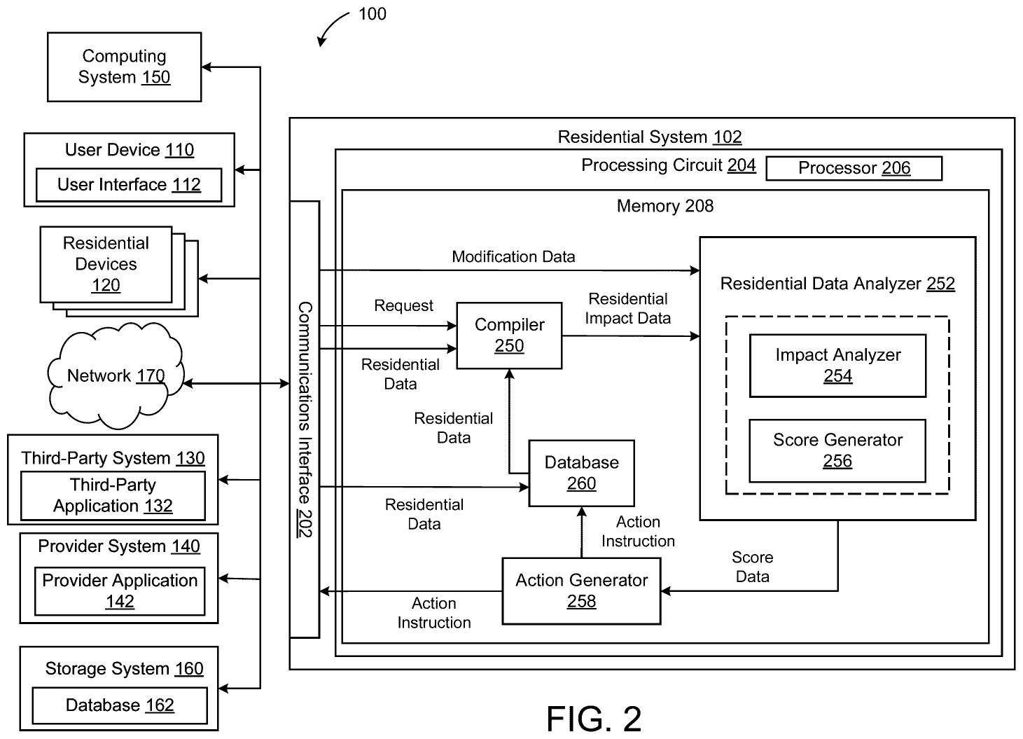

Referring now to FIG. 2, a block diagram of the example residential building assessment system, e.g., the residential system 102, is shown in greater detail, according to some embodiments. As discussed above, the residential system 102 may be configured to initiate one or more actions relating to a residential system (e.g., a residential plumbing system, etc.). For example, the residential system 102 may be configured to (i) generate and/or provide a residential impact score (e.g., a residential plumbing impact score, etc.) and/or (ii) generate a recommendation for improving the residential impact score (e.g., the residential plumbing impact score, etc.).

In various embodiments, the residential system 102 is configured to receive different types of residential data associated with a residential system (e.g., a residential plumbing system, a septic system, etc.), which may be analyzed (e.g., via a trained machine learning model, etc.) to generate a system impact score indicating a remaining useful life of the residential system and/or a component thereof. The residential system 102 may also be configured to estimate an impact of the plurality of different types of residential data on the remaining useful life of the residential system (e.g., the residential plumbing system, etc.), and/or generate the residential impact score (e.g., a residential plumbing impact score, etc.) by predicting the remaining useful life of the residential system using the estimated impacts of the plurality of different types of residential data on the remaining useful life.

In some embodiments, in response to generating the system impact score, the residential system 102 may be configured to initiate an action relating to the residential system and/or a component thereof (e.g., the residential plumbing system and/or a component thereof). For example, in some instances the residential system 102 may generate and/or provide the residential impact score to a user (e.g., on a display of a mobile device or other computing device, or otherwise present the residential impact score to a user, such as visually or audibly via one or more computing devices, AR glasses, VR headsets, voice bots, chatbots, etc.), for example for review and/or analysis. In certain embodiments, the residential system may generate a recommendation for improving the system impact score, for example a recommended maintenance action, a component to add to the system, a component to remove from the system, and/or a component to replace in the subsystem.

As shown in FIG. 2, the residential system 102 may be communicably connected to the user device 110, the residential devices 120, the third-party system 130, the provider system 140, the computing system 150, and the storage system 160 (e.g., via the network 170). In some embodiments, the residential system 102 may be communicably connected to other suitable systems and/or devices (e.g., via the network 170), including those devices mentioned elsewhere herein. It should be understood that some or all of the components of the residential system 102, the user device 110, the residential devices 120, the third-party system 130, the provider system 140, the computing system 150, the storage system 160, and/or the network 170 may be implemented as art of a cloud-based computing system configured to obtain, process, and/or communicate data from one or more external devices or sources.

Similarly, some, or all, of the components of the residential system 102, the user device 110, the residential devices 120, the third-party system 130, the provider system 140, the computing system 150, the storage system 160, and/or the network 170 may be integrated within a single device or be distributed across multiple separate systems or devices. In certain implementations, residential system 102, the user device 110, the residential devices 120, the third-party system 130, the provider system 140, the computing system 150, the storage system 160, and/or the network 170 are components of a controller, a device controller, a field controller, a computer work station, a client device, and/or another system or device that receives, processes, and/or communicates data from/to devices or other data sources.

As shown, the residential system 102 may include a communications interface 202 and a processing circuit 204 having a processor 206 and a memory 208. The communications interface 202 may include wired or wireless communications interfaces (e.g., jacks, antennas, transmitters, receivers, transceivers, wire terminals, etc.) for communicating data between the residential system 102 and external systems or devices (e.g., the user device 110, the residential devices 120, the third-party system 130, the provider system 140, the computing system 150, the storage system 160, etc.). In various embodiments, the communications interface 202 facilitates communications between the residential system 102 and one or more external applications and/or interfaces (e.g., the user interface 112, the third-party application 132, the provider application 142 etc.), for example to allow a remote user or operator to control, monitor, and/or adjust components of the residential system 102.

Further, the communications interface 202 may be configured to communicate with external systems and/or devices using any of a variety of communications protocols (e.g., HTTP(S), WebSocket, CoAP, MQTT, etc.) and/or any of a variety of other protocols. Advantageously, the residential system 102 may obtain, ingest, and process data from any type of system or device, regardless of the communications protocol used by the system or device.

As shown, the residential system 102 may include the processing circuit 204 having the processor 206 and the memory 208. While shown as single components, it should be appreciated that the residential system 102 may include one or more processing circuits, including one or more processors and memory.

In some implementations, the residential system 102 may include a plurality of processors, memories, interfaces, and/or other components distributed across multiple devices or systems, which are communicably coupled via a network (e.g., the network 170). For example, in a cloud-based or distributed implementation, the residential system 102 may include multiple discrete computing devices, each of which include a processor 206, memory 208, communications interface 202, and/or other components of the residential system 102. Tasks performed by the residential system 102 may be distributed across multiple systems or devices, which may be located within a single building or facility or distributed across multiple buildings or facilities. In other embodiments, the residential system 102 itself may be implemented within a single computer (e.g., one server, one housing, etc.). All such implementations are contemplated herein.

The processor 206 may be a general purpose or specific purpose processor, an application specific integrated circuit (ASIC), one or more field programmable gate arrays (FPGAs), a group of processing components, or other suitable processing components. The processor 206 may further be configured to execute computer code or instructions stored in the memory 208 or received from other computer readable media (e.g., USB or other local storage, network storage, a remote server, etc.).

The memory 208 may include one or more devices (e.g., memory units, memory devices, storage devices, etc.) for storing data and/or computer code for completing and/or facilitating the various processes described in the present disclosure. The memory 208 may include random access memory (RAM), read-only memory (ROM), hard drive storage, temporary storage, non-volatile memory, flash memory, optical memory, or any other suitable memory for storing software objects and/or computer instructions. In some embodiments, the memory 208 may include database components, object code components, script components, and/or any other type of information structure for supporting the various activities and information structures described in the present disclosure. The memory 208 may be communicably connected to the processor 206 via the processing circuit 204, and may include computer code for executing (e.g., by the processor 206) one or more processes described herein. When the processor 206 executes instructions stored in the memory 208, the processor 206 may configure the processing circuit 204 to complete such activities.

As shown, the residential system 102 (e.g., the memory 208) may include a request or residential data compiler, shown as a compiler 250, a request or residential data analyzer, shown as a residential data analyzer 252, a trained machine learning model, which may be implemented to perform certain features and/or functions of a residential data impact analyzer and/or a score generator, an action initiator or action generator, shown as action generator 258, and a database 260. The following paragraphs describe some of the general functions performed by each of the components 250-260 of the residential system 102. It should be noted that the number and type of components shown is merely illustrative and, in certain embodiments, implementations of the residential system 102 may have additional, fewer, and/or different components than those illustrated in FIG. 2.

In some embodiments, the compiler 250 may be configured to obtain input data, analyze the input data, and/or generate output data to be communicated to other components of the residential system 102. For example, the compiler 250 may obtain (e.g., receive, request, pull, etc.) a request (e.g., a remaining useful life request, a status request, etc.). The request may be received from an external system or device (e.g., an edge device, the user device 110, etc.), for example via the communications interface 202.

The request may identify a residential building, residential system, residential subsystem, and/or a residential component. The request may identify a residential system, subsystem, and/or component a user or operator desires to know information about (e.g., a remaining useful life, a well-being, an integrity, etc.). For example, the request may identify a plumbing system of a residence, a section of piping within a residence, and/or a plumbing fixture (e.g., a toilet, a sink, etc.) that a user desires to know information about (e.g., an estimated or projected remaining useful life, etc.).

The request may also identify an attribute, characteristic, criteria, and/or quality, for example relating to a residential system, subsystem, and/or component. For example, the request may identify a fluid characteristic (e.g., mineral content, fluid flow characteristics, fluid usage, etc.) and/or a residential system or component (e.g., a plumbing system, a plumbing fixture, etc.), which a user or operator desires to know information about (e.g., how the identified fluid characteristic affects the remaining useful life, well-being, and/or integrity of the system or component, etc.).

In various embodiments, the request identifies a plurality of systems, subsystems, and/or components. Further, the request may identify a plurality of attributes, characteristics, criteria, and/or qualities, for which a user or operator desires to know information about. For example, the request may identify a first fluid characteristic (e.g., a mineral content, etc.) and/or a second fluid characteristic (e.g., a fluid pressure, etc.), as well as a system associated with a residence (e.g., a plumbing system, etc.) and a subsection of the system (e.g., a section of piping in the basement, etc.), for which the user or operator desires to know how the identified characteristics affect the system and subsystem (e.g., how the mineral content and the fluid pressure affect the remaining useful life of the residential plumbing system, and specifically the section of piping in the basement, etc.).

In various embodiments, the request may also include additional information (e.g., a time or time-period associated with the request, etc.) and/or a preference. For example, the request may include a feedback preference indicating a preference to receive feedback in the form of a residential impact score, and/or a preference to receive feedback in the form of a recommended action for improving a residential impact score, as described herein.

In various embodiments, the compiler 250 may be configured to obtain (e.g., receive, request, pull, etc.) residential data. As described herein, the residential data may be received from an external system or device (e.g., an edge device, the user device 110, the residential devices 120, the third-party system 130, the provider system 140, the computing system 150, and/or the storage system 160, etc.), for example via the communications interface 202.

In some embodiments, the residential data may include information or data associated with a user (e.g., the user device 110). For example, the residential data may include user data (e.g., obtained from the user device 110, automatically, or in response to an input from a user or operator, etc.). As described herein, the user data may include geolocation and/or residential telematics data associated with the user device 110. In certain implementations, the user data includes data and/or information gathered and/or captured by the user device 110. For example, the user data may include audiovisual data (e.g., videos, images, voice memos, voicemails, etc.) captured by and/or around the user device 110, for example indicative of a layout, a floorplan, and/or a location/position of components or devices associated with a residence.

In various embodiments, the residential data (e.g., the user data, etc.) also includes information or data associated with a user or operator associated with the user device 110. For example, the user data may include information associated with one or more applications (e.g., housed or executed on the user device 110), including residential and/or maintenance information associated with a user or operator (e.g., via a bill pay or utilities application, a maintenance or residential care application, and/or similar applications, etc.).

In various embodiments, the residential data (e.g., the user data, etc.) also includes information or data associated with a product or service associated with a user or operator of the user device 110. For example, the user data may include information associated with a residential building or residence associated with the user or operator (e.g., a home, apartment, building, etc.). As described herein, the user data associated with a residential building and/or residence associated with the user or operator may include information, such as, geolocation information, a size of the property, a year the residence was built, environmental-related information associated with the residence, construction-related information associated with the residence, system and/or subsystem-related information associated with the residence, information about components of the system and/or subsystem, characteristics associated with the materials used in the systems and/or subsystems, information associated with maintenance, repair, and/or residential care associated with systems, subsystems, and/or components of the residence, and/or other related information and/or data described herein.

In some implementations, the residential data may include information or data associated with a residential device (e.g., the residential device 120). For example, the residential data may include device data (e.g., obtained from the residential device 120, automatically, or in response to an input from a user or operator, etc.). As described herein, the device data may include device related metrics associated with the residential device 120 (e.g., year, make, model, type, quality, smart-functioning capabilities, automated or sensor functionalities, etc.). The device data may also include operational characteristics associated with the operation of the residential device 120 (e.g., fluid or water pressure, fluid or water flow rate, fluid or water drainage, etc.). In certain embodiments, the device data includes fluid characteristics associated with fluid used by the residential device 120 (e.g., a mineral level, a pH level, a contaminant level, a sediment level, etc.).

In various embodiments, the residential data (e.g., the device data) also includes device identification and/or configuration data. For example, the device data may include a device identifier (e.g., an identifier indicating a type of device of the residential device 120, for example a toilet, a bidet, a sink, a bathtub fixture; a water heater, a water softener, a water filtration system; a dishwasher, a washing machine, a refrigerator; a sprinkler head, a spicket, a drainage spout, etc.). In various embodiments, the device data includes information or data associated with a component and/or configuration of the residential device 120 (e.g., information or data associated with a flow sensor, a pressure sensor, a temperature sensor; a pressure valve, a backflow valve; a pipe, a valve, a conduit, a pipe fitting, etc.). In some embodiments, the device data includes material characteristics and/or properties associated with the residential device 120 (e.g., being formed of metal, plastic, cast iron, cross-linked polyethylene (PEX), polyvinyl chloride (PVC), copper, etc.). In various embodiments, the device data includes additional data and/or information associated with the residential device 120 described herein.

In some embodiments, the residential data may include information or data associated with a third-party system (e.g., the third-party system 130). For example, the residential data may include third-party data (e.g., obtained from the third-party system 130, automatically, or in response to an input from a user or operator, etc.). As described herein, the third-party data may include data associated with a public entity (e.g., a city, a town, a village, a municipality, and/or another suitable government entity). For example, the third-party data may include map and/or land plot information (e.g., lot diagrams, water systems, water lines, septic systems, septic lines, etc.). In some embodiments, the third-party data is associated with one or more third-party entities (e.g., gas, electricity, telephone, waste disposal, communications systems, etc. entities), as described herein.

In various embodiments, the residential data (e.g., the third-party data) may include data associated with a public utility entity. For example, the third-party data may include reports, studies, test results, etc. associated with the third-party system 130 (e.g., a water utility entity, etc.), including, for example, water quality information, water characteristic data (e.g., mineral level, potential of hydrogen (pH) level, pH level, contaminant levels, sediment level, etc.), water supply information, water treatment information, and/or other water-related information and data.

In various embodiments, the residential data (e.g., third-party data) may also include data associated with a private utility entity. For example, the third-party data may include water quality information, water characteristic data (e.g., mineral level, pH level, pH level, contaminant level, sediment level, etc.), water supply information, water treatment information, and/or other water-related information and data associated with the private utility entity. In certain implementations, the third-party data includes historic third-party data, and/or any other suitable data associated with the third-party system 130, as described herein.

In various embodiments, the residential data may include information or data associated with a provider system (e.g., the provider system 140). For example, the residential data may include provider data (e.g., obtained from the provider system 140, automatically, or in response to an input from a user or operator, etc.). As described herein, the provider system 140 may be associated with a company that provides protective services (e.g., insurance, etc.) to a user or operator, a company, service provider, and/or one or more products or services. In certain embodiments, the provider data may include one or more policy parameters associated with one or more users, operators, services or service providers, products, and/or services. The provider data (e.g., one or more policy parameters, etc.) may be provided using historical policy parameter information (e.g., historic policy characteristics, etc.), and/or one or more additional policy parameters (e.g., cost, discounts, availability, policy source, a policy availability location, a time over which the policy is available, a product or service over which the policy is available, eligibility requirements, ability to group or bundle different policies or parameters, available discounts or rewards associated with a policy or parameter, etc.), as described herein.

In some implementations, residential data may include information or data associated with a computing system (e.g., the computing system 150) and/or a storage system (e.g., the storage system 160). The residential data may include historic and/or real-time residential related information (e.g., system, subsystem, and/or component information), for example from (e.g., directly, or indirectly) the computing system 150 and/or the storage system 160, as described herein. In some embodiments, residential data may be received by the residential system 102 in real-time and/or at one or more series or intervals (e.g., hourly, daily, etc., automatically in response to a request and/or an event associated with the user device 110, the residential device 120, the third-party system 130, the provider system 140, etc.).

As shown, and as described herein, the compiler 250 may be configured to obtain input data (e.g., a request, residential data, etc.), analyze the input data, and/or generate output data. For example, the compiler 250 may be configured to obtain (e.g., receive, request, pull, etc.) a request and/or residential data, analyze (e.g., compile, process, etc.) the data, and generate residential impact data. The residential impact data may be communicated to another component of the residential system 102 (e.g., the residential data analyzer 252). In certain embodiments, the residential impact data may include data associated with the request and/or residential data, and/or one or more instructions to identify (e.g., generate, determine, etc.) a residential impact score associated with the request and/or the residential data, as will be discussed below.

In some embodiments, the residential data analyzer 252 may be configured to obtain input data, analyze the input data, and/or generate output data to be communicated to other components of the residential system 102. For example, the residential data analyzer 252 may obtain (e.g., receive, request, pull, etc.) residential impact data, analyze the residential impact data, and/or generate score data (e.g., a residential impact score, etc.) associated with the request and/or the residential data (e.g., the residential impact data).

As shown, the residential data analyzer 252 may be configured to analyze the residential impact data and generate score data. As described herein, the residential impact data may include data associated with the request and/or residential data (e.g., user data, residential device data, third-party data, provider data, etc.), and/or one or more instructions to identify (e.g., generate, determine, etc.) a residential impact score associated with the request and/or the residential data. In various embodiments, the score data is or includes a residential impact score (e.g., a residential plumbing impact score, etc.), for example indicating a remaining useful life of the residential system, subsystem, and/or a component thereof (e.g., a remaining useful life of a residential plumbing system, subsystem, and/or component thereof).

In certain implementations, the residential data analyzer 252 is and/or includes one or more trained machine learning models and/or predictive models. For example, the residential data analyzer 252 may be and/or include (e.g., implement, execute, perform, etc.) one or more machine learning models trained using historical residential impact data (e.g., historical request data, historical residential data, historical instructions to generate an impact score, etc.). The machine learning models may be configured to establish one or more correlations between different types of residential data (e.g., user data, residential device data, third-party data, provider data, etc.) and a remaining useful life of a system, subsystem, and/or a component of a residential system, subsystem, and/or component thereof (e.g., a residential plumbing system, subsystem, and/or component thereof).

For example, and as will be described in greater detail herein, the one or more trained machine learning models may be configured to obtain a plurality of different types of residential data (e.g., user data, residential device data, third-party data, provider data, etc.), and analyze the residential data to estimate an impact of each of the different types of residential data on the remaining useful life of the residential system. Further, the one or more trained machine learning models may be configured to use the estimated impacts of each of the different types of residential data to generate a residential impact score that indicates (e.g., predicts, estimates, etc.) the remaining useful life of the residential system. In certain embodiments, the residential data analyzer 252 is configured to train one or more machine learning models and/or predictive models (e.g., using historical residential impact data, etc.). In various embodiments, the residential data analyzer 252 is configured to retrain one or more machine learning models (e.g., one or more trained machine learning models, etc.), for example via input and/or feedback data (e.g., subsequent residential data, user or operator input, etc.).

It should be understood that while the trained machine learning model is described herein as a single machine learning model, it is contemplated that the trained machine learning model may be and/or include one or more machine learning models (e.g., trained machine learning models, etc.). Further, the trained machine learning model may be configured to implement one or more features and/functions described herein. For example, the trained machine learning model may implement, execute, and/or perform one or more features and/or functions performed by the residential data analyzer 252 (e.g., the features and/or functions of the impact analyzer 254, the features and/or functions of the score generator 256, etc.).

In this regard, while FIG. 2 illustrates the residential data analyzer 252 as including the impact analyzer 254 and/or the score generator 256, it should be understood that the trained machine learning model (and/or one or more trained machine learning models, etc.) may be implemented to facilitate executing the functions and/or features of impact analyzer 254 and/or the score generator 256, as described herein. In various implementations, multiple different machine learning models may be trained for different purposes (e.g., one for plumbing assessment, one for electrical assessment, etc.).

In various embodiments, the trained machine learning model may include one or more regression trees, deep neural networks, supervised learning model, unsupervised learning models, nearest neighbor, generative adversarial (GANs), stable diffusers, generative artificial intelligence (GAI), transformers, or many other types of models. In some embodiments, the trained machine learning model utilizes generative artificial intelligence (AI) models (also referred to as generative machine learning (ML) models) and/or other AI/ML models, which may employ supervised, unsupervised, and/or semi-supervised machine learning techniques, which may be used in conjunction with, reinforced and/or reinforcement learning techniques. In some implementations, the trained machine learning model may be configured to implement machine learning, such that trained machine learning model (e.g., the residential data analyzer 252) “learns” to analyze, organize, and/or process data without being explicitly programmed.

In various embodiments, the trained machine learning model may utilize and/or implement a voice bot, chatbot, ChatGPT bot, ChatGPT-based bot, and/or other such generative model (referred to broadly as “chatbot” herein), which may be used for implementing, training, utilizing, and/or otherwise providing an AI or ML model to a user for dialogue interaction (e.g., “chatting”). The chatbot may utilize and/or be trained according to language models, such as natural language processing (NLP) models, large language models (LLMs), and/or generative adversarial network (GAN) techniques.

In various embodiments, the trained machine learning model may be used in conjunction with a machine vision, image recognition, object identification, AR glasses, VR headsets, other input/output devices, and/or other image processing techniques, as described herein. In various embodiments, the trained machine learning model is used with any and/or all of the machine learning, generative artificial intelligence, and/or other advanced computing techniques described herein.

In some embodiments, the trained machine learning model (e.g., the residential data analyzer 252) may be configured to estimate an impact of the residential data, for example on the remaining useful life of a residential system, subsystem, and/or a component thereof. For example, the trained machine learning model (e.g., residential data analyzer 252) may receive different types of residential data (e.g., user data, residential device data, third-party data, provider data, etc.), analyze the different types of residential data, and estimate an impact of each of the different types of data on the remaining useful life of the residential system, subsystem, and/or a component thereof. In this regard, the trained machine learning model (e.g., the impact analyzer 254, etc.) may be configured to obtain residential data, analyze the residential data, and/or estimate an impact of the residential data on the remaining useful life of the residential system, subsystem, and/or a component thereof.

As an illustrative example, the trained machine learning model (e.g., the residential data analyzer 252, the impact analyzer 254, etc.) may be configured to receive residential data including different types of residential data, as described herein. For example, the residential data may include user data, for example data relating to a residential building associated with a user or operator (e.g., including a geolocation of the residential building, an age of the residential building, etc.). The residential data may also include residential device data, including data associated with a residential plumbing system of the residential building (e.g., an age of the plumbing system, an age and/or device identifier associated with a water softener, an age and/or device identifier associated with a water heater, an indication of one or more materials used in the plumbing system and/or one or more plumbing devices, etc.). The residential data may also include third-party data, including data from a utility entity (e.g., a water utility entity, etc.), including data associated with a utility associated with the third-party (e.g., water quality information, water characteristic data, including mineral level, pH level, pH level, contaminant level, sediment level, etc., water supply information, water treatment information, etc.). The residential data may also include provider data, including data associated with a provider system (e.g., historical policy parameters associated with the residential building and/or similarly situated residential buildings, historical policy requests associated with the residential building and/or similarly situated residential buildings, etc.). In some embodiments, the residential data also includes data associated with one or more computing systems and/or storage systems.

The trained machine learning model (e.g., the residential data analyzer 252, the impact analyzer 254, etc.) may further be configured to analyze each of the different types of residential data, and estimate the impact of each of the different types of residential data on the remaining useful life of the residential system and/or a component thereof. For example, the trained machine learning model (e.g., the impact analyzer 254, etc.) may be configured to analyze the user data (e.g., a geolocation and/or age of the residential building, etc.) and determine and/or generate an estimated remaining useful life of the residential plumbing system (e.g., a baseline remaining useful life of the residential plumbing system, for example 50 years, etc.).

Further, the trained machine learning model (e.g., the impact analyzer 254, etc.) may also be configured to analyze the third-party data (e.g., water characteristic data, including mineral level, pH level, pH level, contaminant level, sediment level, etc.), and estimate an impact of the third-party data (e.g., water characteristic data) on the remaining useful life of the residential plumbing system (e.g., the baseline remaining useful life). For example, the trained machine learning model may analyze the water characteristic data to determine that the water provided to the residential building has a high level of dissolved minerals (e.g., calcium, magnesium, etc.), and estimate that the high level of dissolved minerals may impact the baseline remaining useful life of the residential plumbing system (e.g., estimate that the high level of dissolved minerals may reduce the remaining useful life of the plumbing system by 5 years, etc.).

Similarly, the trained machine learning model (e.g., the impact analyzer 254, etc.) may also be configured to analyze the residential device data, and estimate an impact of the residential device data on the remaining useful life of the residential plumbing system (e.g., the baseline remaining useful life). For example, the trained machine learning model may analyze an age of the plumbing system of the residential building (e.g., an original plumbing system installed in the residential building, for example being 15 years old, etc.), and estimate that the age of the plumbing system (e.g., 15 years old) may impact the baseline remaining useful life of the residential building (e.g., estimate that the original plumbing being 15 years old may not affect and/or improve the remaining useful life of the plumbing system, for example by 2 years, etc.).

Further, the trained machine learning model may analyze an age and/or device identifier associated with a water softener and/or a water heater, and estimate an impact. For example, the trained machine learning model may analyze the presence of and/or the type of water softener, and estimate that the water softener may not affect and/or improve the remaining useful life of the plumbing system (e.g., by 1 year, etc.). Further, the trained machine learning model may analyze the age of the water heater as being 5 years old and the last water heater flush being 2 years ago, and estimate that the water heater may impact the remaining useful life of the plumbing system (e.g., estimate the 5-year-old water heater with the last flush being two years ago may reduce the remaining useful life of the plumbing system, for example by 3 years, etc.). In addition, the trained machine learning model may analyze one or more materials used in the plumbing system and/or one or more plumbing devices, and estimate an impact. For example, the trained machine learning model may analyze the fact that the plumbing system includes PVC, and estimate that the material impacts the remaining useful life of the plumbing system (e.g., estimate the use of PVC material may reduce the remaining useful life of the plumbing system, for example by 2 years, etc.).

The trained machine learning model (e.g., the impact analyzer 254, etc.) may also be configured to analyze the provider data, and estimate an impact of the provider data on the remaining useful life of the residential plumbing system (e.g., the baseline remaining useful life). For example, the trained machine learning model may analyze historical policy parameters and/or requests associated with the residential building indicating that the water softener was replaced 2 years ago, and estimate that the new water softener may not affect and/or improve the remaining useful life of the plumbing system (e.g., by 5 years, etc.).

In this regard, using the different types of residential data described herein (e.g., user data, residential device data, third-party data, provider data, etc.), the trained machine learning model (e.g., residential data analyzer 252, the impact analyzer 254, etc.) may analyze each of the different types of residential data, and estimate the impact of each of the different types of residential data on the remaining useful life (e.g., the baseline remaining useful life, etc.) of the residential system and/or a component thereof (e.g., the residential plumbing system and/or a component thereof, etc.). As described herein, it should be understood that in certain embodiments functions of the trained machine learning model (e.g., residential data analyzer 252, the impact analyzer 254, etc.) are implemented via a single trained machine learning model. However, in various embodiments the functions of the trained machine learning model is/are implemented via a plurality of trained machine learning models. As will be discussed in further detail below, the estimated impacts of the different types of residential data on the remaining useful life of the residential system may further be used to generate a residential impact score indicating (e.g., predicting, estimating, etc.) the remaining useful life of the residential system.

In certain implementations, the trained machine learning model (e.g., the residential data analyzer 252) may be configured to generate a residential impact score, for example by predicting the remaining useful life of the residential system, subsystem, and/or a component thereof. For example, the trained machine learning model (e.g., the residential data analyzer 252) may utilize the estimated impacts of the different types of residential data on the remaining useful life of the residential system (e.g., estimated impacts of the user data, the residential device data, the third-party data, the provider data, etc.), as described herein, and generate a residential impact score by predicting the remaining useful life of the residential system. In this regard, the trained machine learning model (e.g., the score generator 256) may also be configured to obtain estimated impacts of different types of residential data, analyze the estimated impacts, and generate a residential impact score indicating (e.g., predicting, estimating, etc.) a remaining useful life of the residential system, subsystem, and/or a component thereof.

As an illustrative example, the trained machine learning model (e.g., the score generator 256, etc.) may be configured to obtain (e.g., receive, request, pull, etc.) estimated impacts of the different types of residential data, as described herein. For example, the trained machine learning model may be configured to obtain an estimated remaining useful life of a residential plumbing system (e.g., a baseline remaining useful life of the residential plumbing system) associated with user data. The trained machine learning model may further be configured to obtain an estimated impact of, for example, water characteristic information (e.g., level of dissolved minerals, etc.) associated with third-party data on the remaining useful life of the residential plumbing system.

Further, the trained machine learning model may be configured to obtain an estimated impact of, for example, an age of the plumbing system, the presence of and/or the type of water softener, the age and/or characteristics of a water heater, and/or one or more materials used in the plumbing system (e.g., associated with residential device data) on the remaining useful life of the residential plumbing system. In various embodiments, the trained machine learning model may also be configured to obtain an estimated impact of, for example, historic policy parameters and/or requests associated with a provider system on the remaining useful life of the residential plumbing system.

The trained machined learning model (e.g., the score generator 256, etc.) may also be configured to analyze each of the estimated impacts on the remaining useful life of the plumbing system, and generate a residential plumbing impact score indicating (e.g., predicting, estimating, etc.) a remaining useful life of the residential plumbing system (and/or a component thereof). As described herein, “residential plumbing impact score,” “residential impact score,” “impact score,” and/or similar terms may represent an estimated (e.g., predicted, overall, etc.) impact of the current operating conditions of the residential plumbing system and/or the residential system on the respective system (e.g., the residential plumbing system, etc.), associated systems and/or subsystems, and/or a user or operator.

For example, the residential plumbing impact score may indicate an estimated amount of potential damage the current operating conditions may potentially impart on one or more components of the residential plumbing system (e.g., a water softener, a water heater, plumbing fixtures, etc.) and/or one or more components of related systems (e.g., a dishwasher, a washing machine, etc.). Further, the residential plumbing impact score may indicate an estimated level of inefficiency in the current operating conditions (e.g., inefficient water usage, inefficient energy consumption, inefficient financial resource consumption, etc.) In addition, the residential plumbing impact score may indicate a level of potential health and/or safety risks associated with the current operating conditions (e.g., potential health and/or safety risks associated with a potential failure and/or potential damage to the residential building, for example a potential flooding and/or leaking event, potential bacterial or erosive exposure to an undetectable flooding and/or leaking event, etc.).

As described herein, a residential impact score, a residential plumbing impact score, and/or an impact score may be calculated and/or generated using one or more rules, algorithms, and/or models (e.g., the trained machine learning model, etc.). For example, the trained machine learning model (e.g., the score generator 256) may be configured to generate a residential plumbing impact score using one or more rules and/or rule-based logic. For example, the rules may be used to estimate a remaining useful life of one or more residential system, subsystems, and/or components thereof (e.g., under current operating conditions). The rules and/or rule-logic may be used along with historical residential related data, and/or may be iteratively updated and/or trained using subsequent residential related data.

As shown, and as described herein, the residential data analyzer 252 (e.g., the trained machine learning model, etc.) may be configured to obtain input data (e.g., residential impact data, etc.), analyze the input data, and/or generate output data. For example, the trained machine learning model may be configured to obtain (e.g., receive, request, pull, etc.) residential impact data, analyze (e.g., compile, process, etc.) the data, and generate score data. The score data may indicate an estimated remaining useful life of a residential system, subsystem, and/or a component thereof. The score data may be communicated to another component of the residential system 102 (e.g., the action generator 258).

In some embodiments, the action generator 258 may be configured to obtain input data, analyze the input data, and/or generate output data to be communicated to other components of the residential system 102. For example, the residential data analyzer 252 may obtain (e.g., receive, request, pull, etc.) score data, analyze the score data, and/or generate an action instruction associated with the score data.

In various embodiments, the action generator 258 may generate an action instruction that includes a residential impact score. For example, the action generator 258 may generate an action instruction that includes a user interface that provides a residential impact score (e.g., to a user or operator, etc.), or otherwise audibly or visually presents the residential impact score, such as via a computing device, display screen, or voice bot. In certain implementations, the residential impact score indicates a remaining useful life of an associate residential system, subsystem, and/or a component thereof.

In some implementations, the action generator 258 is configured to generate the residential impact score including one or more indicators. For example, the action generator 258 may generate a residential impact score that includes an indicator indicating a potential level of impact on the system or subsystem (e.g., low, medium, high, etc. impact on a toilet or sink associated with the residential plumbing system, etc.), a potential level of impact on an associated system or subsystem (e.g., low, medium, high, etc. impact on a dishwasher or washing machine associated with the residential building, etc.), and/or a potential level of impact on a user or operator (e.g., low, medium, high, etc. potential heath and/or safety risk associated with a potential damage and/or failure, etc.).

In various embodiments, the action generator 258 may generate an action instruction that includes a recommendation. For example, the action generator 258 may generate an action instruction that includes a recommendation for improving the residential impact score (e.g., a maintenance action, a modification action, a recommendation to cease certain actions, etc.). The recommendation may include, for example, at least one of a recommended maintenance action, a component to add to a system or subsystem (e.g., a filtration system to the residential plumbing system, etc.), a component to remove from a system or subsystem (e.g., a stop or pressure valve, shut off valve, etc.), a component to replace in a system or subsystem (e.g., a filter or vent, etc.), and/or other similar recommendation.

In some implementations, the action generator 258 may generate an action instruction that includes additional information. For example, the action generator 258 may generate an action instruction that includes a recommendation (e.g., for improving the residential impact score, etc.), along with additional information associated with the recommendation. In some embodiments, the action generator 258 may be configured to generate a recommendation including a proposed maintenance and/or service provider, a proposed maintenance or service window, a proposed cost and/or review information associated with the maintenance and/or service provider, and/or additional information associated with the recommendation.

In certain embodiments, the residential system 102 (e.g., the action generator 258, etc.) may be configured to analyze residential data in generating the recommendation and/or the associated information. For example, the action generator 258 may be configured to analyze user data including, for example, a schedule or calendar associated with a user, third-party data including information relating to service and/or maintenance providers (e.g., location, reviews, cost, services offered, availability, etc.), and/or other associated information (e.g., a budget associated with a user, a service or repair timeline, etc.). In some implementations, the residential system 102 (e.g., the action generator 258, etc.) may be configured to analyze the user data and/or the third-party data, for example to generate a recommendation that includes a proposed maintenance or service provider (e.g., via third-party or user reviews, etc.), a proposed maintenance or service window where the user and/or the third-party is available to complete the maintenance and/or service, a proposed cost or timeline associated with the proposed maintenance or service, and/or other associated information. In some implementations, the action generator 258 may be configured to generate an action instruction (e.g., including a recommendation, additional information associated with the recommendation, etc.) that includes a user interface that provides the recommendation and/or additional information (e.g., a proposed maintenance provider, a proposed time or window for service, a proposed cost, etc.), for example for review by the user or operator (e.g., for the user to approve, reject, propose a modification or alternative service, time, cost, etc.).

In some embodiments, the recommendation may be generated via a machine learning model (e.g., a trained machine learning model, etc.), for example trained using different potential actions that could be taken (e.g., maintenance actions, repair actions, etc.) relating to different combinations of input conditions (e.g., geographic location, materials, system configurations, etc.). In various embodiments, the recommendation may be generated via a generative model, for example to predict an impact of different actions that could be taken (e.g., maintenance actions, repair actions, etc.) and/or to identify an action that most positively impacts the estimated remaining useful life. In various embodiments, the recommendation may be generated using any and/or all of the various machine learning and/or artificial intelligence models and/or methods described herein.

In certain embodiments, the action generator 258 may generate an action instruction that includes information relating to one or more policy parameters. As described herein, the action generator 258 may generate an action instruction that includes a policy parameter associated with a residential impact score and/or an associated recommendation. For example, as a benefit or reward for having a predetermined residential plumbing impact score (e.g., above a predetermined threshold, within a predetermined range, etc.), at least one policy parameter may be provided as a benefit to a user (e.g., an insurance policy, a discount, a cost-savings, a cost reduction to an existing policy, an increase in coverage, an increase in duration of coverage of a policy, etc.). Further, as a benefit or reward to implementing a maintenance action and/or modification, at least one policy parameter may be provided as a benefit to a user.

In various embodiments, the action generator 258 may further be configured to communicate the action instruction to one or more devices, systems, and/or environments. For example, the action generator 258 may be configured to communicate the action instruction to the user device 110 (e.g., via the communications interface 202), for example for display (e.g., via the user interface 112) or voice reproduction, such as in the case of a voice bot, ChatGPT bot, etc.

Additionally or alternatively, the action generator 258 may be configured to communicate the action instruction to the database 260 and/or the storage system 160 (e.g., via the communications interface 202 via the network 170), for example for storage and/or subsequent action instruction generation. In some embodiments, the action generator 258 may be configured to communicate the action instruction to the third-party system 130, the provider system 140, and/or the computing system 150 (e.g., via the communications interface 202 via the network 170), for example for storage and/or subsequent analysis (e.g., authorization, verification, etc.).

In some embodiments, the database 260 is configured to obtain (e.g., receive, request, pull, etc.), store, and/or output (e.g., provide, send, etc.) data and/or information. For example, the database 260 may be configured to receive residential data (e.g., user data, residential device data, third-party data, provider data, etc.), as described herein. In certain implementations, the database 260 may be configured to provide data (e.g., residential data, etc.) to other components of the residential system 102 (e.g., the compiler 250, etc.). For example the database 260 may be configured to obtain residential data (e.g., associated with a user, associated with a residential building or residential complex, associated with a town or municipality, associated with utility entity, etc.), store the residential data, and/or provide the residential data to the compiler 250, for example for use in subsequent assessments of remaining useful lives of residential systems (e.g., the residential system, another residential system, etc.).

In various embodiments, the systems, methods, and/or functionalities described herein may be performed in a sequence (e.g., over a period of time, etc.), as part of an iterative process, repeated, and/or be otherwise performed. For example, and as described herein, the action generator 258 may generate an action instruction, which may include a residential impact score (e.g., a residential plumbing impact score, etc.), an associated recommendation (e.g., a recommendation for improving the residential impact score, etc.), and/or additional information associated with the recommendation (e.g., a proposed maintenance or service provider, a proposed maintenance or service window where the user and/or the third-party is available to complete the maintenance and/or service, a proposed cost or timeline associated with the proposed maintenance or service, etc.).

In some implementations, the action instruction (e.g., the residential impact score, the associated recommendation, etc.) may be provided to a user or operator (e.g., via a user interface, or otherwise audibly or visually, etc.). In certain embodiments, the action instruction includes one or more policy parameters (e.g., associated with the residential impact score, the associated recommendation, etc.), as described herein.

In some embodiments, the user may assess the residential impact score and/or the associated recommendation, and implement one or more actions. For example, a user or operator may implement one or more preventative and/or mitigative actions, including a maintenance action (e.g., clean or flush a component or system, etc.), a modification action (e.g., repair, replace, and/or remove a component, etc.), and/or an action to cease performing certain actions (e.g., cease leaving water running, etc.). The residential system 102 may be configured to receive information and/or data associated with the one or more implemented actions (e.g., maintenance action, modification action etc.). For example, the residential system 102 may receive residential modification data or modification data (e.g., automatically, or in response to an input, for example from the user device 110 via the user interface 112, via the residential device 120, via the third-party system 130, via the provider system 140, etc.), for example via the communications interface 202 (e.g., via the network 170).

As described herein, the residential data analyzer 252 may be configured to obtain input data, analyze the input data, and/or generate output data to be communicated to other components of the residential system 102. For example, the residential data analyzer 252 may obtain (e.g., receive, request, pull, etc.) modification data and/or analyze the modification data. In some embodiments, the residential data analyzer 252 is configured to obtain the modification data, and compare the modification data with one or more sets of score data (e.g., a residential impact score, a recommendation associated with a residential impact score, etc.), for example to via communication with the database 260. The residential data analyzer 252 may be configured to compare the modification data with one or more sets of score data, for example to verify that an action associated with the modification data (e.g., a maintenance action, a modification action, etc.) matches a recommendation for improving a residential impact score.

In some implementations, the residential data analyzer 252 may be configured to obtain (e.g., receive, request, pull, etc.) modification data at predetermined intervals. For example, the residential data analyzer 252 may be configured to obtain modification data in real-time (e.g., via the user device 110 providing information relating to one or more service and/or maintenance actions, via the residential device 120 in response to the residential device 120 receiving a service or maintenance action, via the third-party system 130, etc.). In certain implementations, the residential data analyzer 252 may be configured to obtain modification data may be configured to obtain modification data at predetermined time intervals (e.g., every hour, 2 hours, 6 hours, 12 hours, 24 hours, bi-weekly, weekly, etc.).

In some embodiments, the residential system 102 may be configured to monitor one or more components of the residential services system 100 (e.g., the user device 110, the residential device 120, etc.), for example to determine whether a modification (e.g., service, maintenance, repair, etc. action) matches a recommendation, as described herein. For example, the residential system 102 (e.g., the residential data analyzer 252, etc.) may be configured to monitor the residential device 120 (e.g., a water heater, etc.), for example to determine whether a modification matches a recommendation (e.g., determine whether the water heater was flushed in accordance with the recommendation, etc.). In some implementations, the residential system 102 may be configured to monitor and/or determine additional information associated with a modification (e.g., a time associated with a maintenance or repair action, a person and/or provider that performs the action, a type of material or component used in the maintenance or repair action, etc.), for example to provide a benefit and/or reward for implementing a recommended preventative and/or mitigative action, as described herein. In some implementations, the residential system 102 may be configured to receive data from other systems, such as a system associated with a service provider, to validate whether a recommended improvement has been implemented.

In various embodiments, the residential data analyzer 252 is also configured to generate additional score data (e.g., modified residential score data, etc.). For example, the trained machine learning model (e.g., the residential data analyzer 252) may be configured to generate a modified residential impact score associated with the modification data, as described herein. The modified residential impact score maybe compared with one or more sets of score data (e.g., a previously generated residential impact score associated with a building system, subsystem, and/or component thereof, etc.). In certain implementations, and based upon the comparison, the residential data analyzer 252 may determine that the modified residential impact score indicate an improvement in the residential impact score (and/or the associated predicted remaining useful life of the residential system, etc.).

In some embodiments, the modified score data may be communicated to another component of the residential system 102. For example, and as described herein, the modified score data may be communicated to the action generator 258. The action generator 258 may be configured to generate an action instruction that includes a user interface that provides a modified residential impact score and/or an associated recommendation, as described herein. In certain embodiments, the action generator 258 may also generate an action instruction that includes information relating to one or more policy parameters.

For example, the action generator 258 may generate an action instruction that includes a policy parameter associated with the modified residential impact score and/or an associated recommendation. For example, as a benefit or reward for having the modified residential plumbing impact score meet a predetermined threshold (e.g., above a predetermined threshold, within a predetermined range, etc.), at least one policy parameter may be provided as a benefit to a user (e.g., a discount, a cost-savings, a cost reduction to an existing policy, an increase in coverage, an increase in duration of coverage of a policy, etc.). Further, as a benefit or reward to implementing a maintenance action and/or modification (e.g., a recommended maintenance action to reduce, prevent, or mitigate damage to home or other damage; a recommended modification; etc.), at least one policy parameter may be provided as a benefit to a user.

In this regard, the systems, methods, and/or functionalities described herein may be implemented as part of an iterative process, for example to provide users and/or operators with information associated with available actions (e.g., preventative actions, mitigative actions, etc.), which may afford users additional benefits and/or advantages. For example, the systems and methods described herein use a trained machine learning model and different types of residential data (e.g., data which is otherwise inaccessible, data which is difficult to obtain, and/or data which is not traditionally correlated and/or associated, etc.) to generate a residential impact score, which may be utilized by users, for example, to implement one or more preventative and/or mitigative actions. For example, a user may implement a preventative and/or mitigative action (e.g., a maintenance and/or modification action, a repair action, etc.) to reduce and/or prevent potential damage to components of a residential building (e.g., components of a plumbing system or subsystem, components of an associated system or subsystem, for example a refrigerator or dishwasher, etc.), thereby reducing resource consumption associated with the potential damage (e.g., water, electrical, and/or energy consumption associated with operating a damaged component, financial resources associated with repairing and/or replacing damaged components, etc.).

Further, the residential impact score may be utilized, for example, to implement a preventative and/or mitigative action (e.g., a maintenance and/or modification action, a repair action, etc.) to reduce and/or prevent potential inefficient operating conditions of a component of the residential building, thereby also reducing resource consumption associated with the inefficient operating conditions (e.g., water, electrical, and/or energy consumption, etc.). In addition, the residential impact score may advantageously be utilized, for example, to implement a preventative and/or mitigative action (e.g., a maintenance and/or modification action, etc.) to reduce potential health and/or safety risks associated with a potential failure and/or potential damage to the residential building (e.g., health and/or safety risks associated with a potential flooding and/or leaking event, health and/or safety risks associated with a potentially undetectable flooding and/or leaking event, for example potential exposure to bacteria or mold, or rotting or erosive conditions in the residential building, etc.). In some implementations, as a benefit or reward for implementing a maintenance action and/or modification (e.g., a recommended maintenance action, a recommended modification, etc.) and/or for having a certain modified residential impact score, at least one policy parameter may be provided as a benefit to a user.

### Exemplary Residential System & Functionality

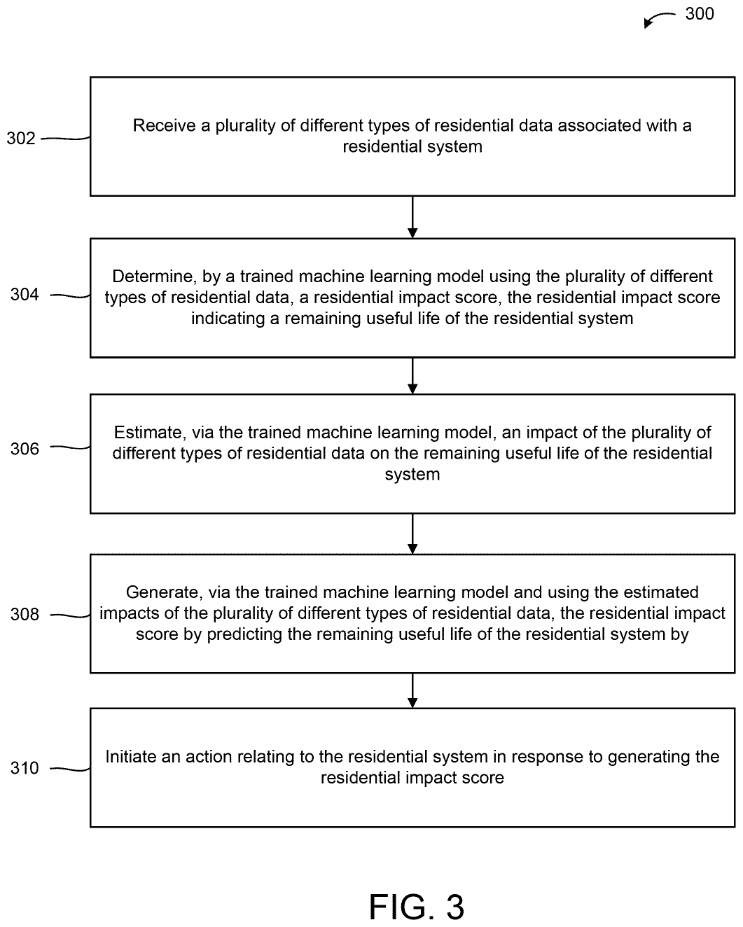

Referring now to FIG. 3, a computer-implemented or computer-based process, shown as process 300, for assesses a remaining useful life of a residential system (or component thereof) is shown, according to various embodiments. Computer-implemented process 300 may be implemented by any and/or all the components of the residential services system 100 of FIGS. 1-2 (e.g., the residential system 102, etc.). It should be appreciated that any and/or all the process 300 may be implemented by other systems, devices, and/or components (e.g., components of the residential services system 100, the residential system 102, etc.). Further, it should be appreciated that in some embodiments, process 300 may implemented using additional, different, and/or fewer operations, actions, and/or functionality.

Computer-implemented process 300 may include receiving residential data (block 302), according to some embodiments. The residential data may be associated with a residential system, subsystem, and/or component thereof. For example, the residential data may be associated with a residential plumbing system.

In certain implementations, the residential data may include a plurality of different types of residential data. For example, the residential data may include a plurality of different types of residential data (e.g., user data, device data, third-party data, provider data, data from a computing system and/or a storage system, etc.), which may be received from an external or remote device (e.g., an edge device, the user device 110, the residential device, the provider system 140, etc.), as described herein.

In certain embodiments, the residential data may include user data (e.g., obtained from the user device 110, automatically, or in response to an input from a user or operator, etc.). As described herein, the user data may include geolocation and/or residential telematics data associated with the user device 110, and/or audiovisual data (e.g., videos, images, voice memos, voicemails, etc.) captured by and/or around the user device 110 (e.g., indicative of a layout, a floorplan, etc.). The user data may also include information or data associated with a user or operator associated with the user device 110 (e.g., information associated with one or more applications housed or executed on the user device 110, including a bill pay or utilities application, a maintenance or residential care application, and/or similar applications, etc.). In various embodiments, the user data includes information or data associated with a product or service associated with a user or operator of the user device 110, as described herein.

In some embodiments, the residential data may include device data (e.g., obtained from the residential device 120, automatically, or in response to an input from a user or operator, etc.). As described herein, the device data may include device related metrics associated with the residential device 120, operational characteristics associated with the operation of the residential device 120, and/or other characteristics associated with a fluid used by the residential device 120 (e.g., a mineral level, a pH level, a contaminant level, a sediment level, etc.). The device data may also include device identification and/or configuration data, data associated with a component and/or configuration of the residential device 120, and/or material characteristics and/or properties associated with the residential device 120, as described herein.

In some implementations, the residential data may include third-party data (e.g., obtained from the third-party system 130, automatically, or in response to an input from a user or operator, etc.). As described herein, the third-party data may include data associated with a public entity (e.g., a city, a town, and/or another suitable government entity), data associated with a public utility entity (e.g., a water utility entity, etc.), and/or data associated with a private utility entity (e.g., a private water utility entity). In certain implementations, the third-party data includes historic third-party data, and/or any other suitable data associated with the third-party system 130, as described herein.

In certain implementations, the residential data may include provider data (e.g., obtained from the provider system 140, automatically, or in response to an input from a user or operator, etc.). As described herein, the provider system 140 may be associated with a company that provides protective services (e.g., insurance, etc.) to a user or operator, a company, service provider, and/or one or more products or services, and/or may include one or more policy parameters associated with one or more users, operators, services or service providers, products, and/or services. In various embodiments, residential data may include data associated a computing system (e.g., the computing system 150) and/or a storage system (e.g., the storage system 160).

Computer-implemented process 300 may include determining a residential impact score (block 304), according to some embodiments. The residential impact score may be a residential plumbing impact score, for example indicating a remaining useful life of the residential plumbing system (and/or a component thereof). The residential plumbing impact score maybe determined using a trained machine learning model, and/or one or more trained machine learning models, using a plurality of different types of residential data (e.g., user data, residential device data, third-party data, provider data, etc.).

In certain embodiments, the trained machine learning model is configured to establish one or more correlations between different types of residential data (e.g., user data, residential device data, third-party data, provider data, etc.) and a remaining useful life of a system, subsystem, and/or a component of a residential system, subsystem, and/or component thereof (e.g., a residential plumbing system, subsystem, and/or component thereof). For example, the trained machine learning model may be configured to establish one or more correlations between different types of residential data and a remaining useful life of a plumbing system. As described herein, the trained machine learning model is used with any and/or all of the machine learning, generative artificial intelligence, and/or other advanced computing techniques described herein.

Computer-implemented process 300 may include estimating an impact of the residential data on the remaining useful life of the residential system (block 306), according to some embodiments. For example, the trained machine learning model may be configured to estimate an impact of each of the plurality of different types of residential data (e.g., user data, residential device data, third-party data, provider data, etc.) on the remaining useful life of the residential plumbing system.

For example, the trained machine learning model may be configured to receive residential data (e.g., user data indicating a geolocation and/or age of the residential building, etc.) and determine an estimated remaining useful life of the residential plumbing system (e.g., a baseline remaining useful life of the residential plumbing system, for example 50 years, etc.). Further, the trained machine learning model may be configured to analyze residential data (e.g., third-party data indicating characteristics of water provided to the residential building; residential device data indicating an age of the plumbing system, an age and/or device identifier associated with a water softener, an age and/or device identifier associated with a water heater, an indication of one or more materials used in the plumbing system and/or one or more plumbing devices; provider data indicating historical policy parameters and/or requests associated with the residential building, etc.), and/or estimate an impact of each of the residential data sets on the remaining useful life of the residential plumbing system (e.g., relative to the baseline, etc.).

Computer-implemented process 300 may include generating a residential impact score using the estimated impacts of the residential data (block 308), according to some implementations. For example, the trained machine learning model maybe configured to obtain estimated impacts of the different types of residential data (e.g., user data, residential device data, third-party data, provider data, etc.), and, using the estimated impacts, generate a residential impact score indicating (e.g., predicting, estimating, etc.) a remaining useful life of the residential plumbing system.

For example, the trained machine learning model may be configured to obtain an estimated remaining useful life of a residential plumbing system (e.g., a baseline remaining useful life of the residential plumbing system), for example associated with user data. The trained machine learning model may further be configured to obtain an estimated impact of, for example, water characteristic information (e.g., level of dissolved minerals, etc.) associated with third-party data; an estimated impact of, for example, an age of the plumbing system, the presence of and/or the type of water softener, the age and/or characteristics of a water heater, and/or one or more materials used in the plumbing system (e.g., associated with residential device data); and an estimated impact of, for example, historic policy parameters and/or requests associated with a provider system on the remaining useful life of the residential plumbing system. Using the estimated impacts on the remaining useful life of the plumbing system, the trained machine learning model may be configured generate a residential plumbing impact score indicating (e.g., predicting, estimating, etc.) a remaining useful life of the residential plumbing system (and/or a component thereof).

Computer-implemented process 300 may include initiating an action relating to the residential system using the residential impact score (block 310), according to various embodiments. For example, in response to generating the residential plumbing impact score, an action may be initiated relating to the residential plumbing system. As described herein, initiating an action may include generating a user interface that provides the residential plumbing impact score (e.g., to a user or operator, etc.), or otherwise audibly and/or visually presents the residential plumbing impact score, such as via a computing device, display screen, or voice bot.

In certain implementations, initiating an action may include providing a recommendation. For example, a recommendation may be provided for improving the residential plumbing impact score. The recommendation may include, for example, at least one of a recommended maintenance action, a component to add to the plumbing system, a component to remove from the plumbing, a component to replace in a plumbing system, and/or any other suitable recommendation (e.g., a recommendation to cease performing certain actions, etc.). As described herein, the recommendation may also include additional information associated with the recommendation (e.g., a proposed maintenance or service provider, a proposed maintenance or service window where the user and/or the third-party is available to complete the maintenance and/or service, a proposed cost or timeline associated with the proposed maintenance or service, etc.).

In some embodiments, computer-implemented process 300 may include providing one or more policy parameters. For example, the action instruction may include information relating to one or more policy parameters (e.g., relating to the residential plumbing impact score and/or an associated recommendation, etc.). For example, as a benefit or reward for having a predetermined residential plumbing impact score (e.g., above a predetermined threshold, within a predetermined range, etc.), at least one policy parameter may be provided as a benefit to a user (e.g., an insurance policy, a discount, a reward, a cost reduction to an existing policy, an increase in coverage, an increase in duration of coverage of a policy, etc.). Further, as a potential benefit or reward to implementing a recommended preventative and/or mitigative maintenance action and/or modification, at least one policy parameter may be provided as a potential benefit to a user.

In certain embodiments, computer-implemented process 300 may include receiving modification data, maintenance data, and/or repair data. For example, in response to initiating an action relating to the residential plumbing system, a user may assess the residential plumbing impact score and/or the associated recommendation, and/or implement one or more actions. For example, the user or operator may implement one or more preventative and/or mitigative actions, including a maintenance action, a modification action, and/or an action to cease performing certain actions. In response to the one or more implemented actions (e.g., maintenance action, modification action etc.), information and/or data associated with the one or more implemented actions may be received (e.g., via the user device 110, the residential device 120, the third-party system 130, the provider system 140, etc.). In some implementations, one or more components of the residential services system 100 (e.g., the user device 110, the residential device 120, the third-party system 130, the provider system 140, etc.) is/are monitored, for example to obtain information and/or data associated with one or more actions (e.g., an implemented preventative or mitigative action, etc.).

In certain implementations, the modification data may be received and/or compared with one or more sets of score data (e.g., a residential plumbing impact score, an associated recommendation, etc.), for example to verify that an action associated with the modification data (e.g., a maintenance action, a modification action, etc.) matches a recommendation for improving a residential plumbing impact score. In various embodiments, using the modification data, a modified residential plumbing impact score may be determined. The modified residential plumbing impact score maybe compared with one or more sets of score data (e.g., a previously generated residential plumbing impact score, for example associated with the residential plumbing system and/or a component thereof, etc.), for example to determine that the modified residential plumbing impact score indicates an improvement in the residential plumbing impact score and/or the associated predicted remaining useful life of the residential plumbing system.

In some embodiments, computer-implemented process 300 may include initiating an action based upon the generation of the modified residential plumbing impact score. As described herein, the action instruction may include a user interface that provides a modified residential impact score and/or an associated recommendation. Further, the action instruction may include a policy parameter associated with the modified residential impact score (and/or an associated recommendation). For example, and as described herein, as a benefit or reward for having the modified residential plumbing impact score meet a predetermined threshold (e.g., above a predetermined threshold, within a predetermined range, etc.), at least one policy parameter may be provided as a benefit to a user. Further, as a benefit or reward to implementing a maintenance action and/or modification (e.g., a recommended maintenance action, a recommended modification, etc.), at least one policy parameter may be provided as a benefit to a user.

Advantageously, the systems and methods described herein leverage the advantages provided by a trained machine learning model, using different types of residential data (e.g., data which is otherwise inaccessible, data which is difficult to obtain, and/or data which is not traditionally correlated and/or associated, etc.), in order to generate a residential impact score, which may be utilized by users, for example, to implement one or more beneficial preventative and/or mitigative actions.

For example, using the residential plumbing impact score a user may implement a preventative and/or mitigative action to reduce and/or prevent potential damage to and/or inefficient operation conditions of components of a residential building, thereby reducing resource consumption associated with the potential damaged and/or inefficient conditions (e.g., water consumption associated with operating a damaged and/or inefficient component, resources associated with repairing/replacing damaged and/or inefficient components, etc.). In addition, the residential plumbing impact score may advantageously be utilized, for example, to implement a preventative and/or mitigative action to reduce potential health and/or safety risks associated with a potential failure and/or potential damage to the residential building (e.g., health and/or safety risks associated with a potential flooding and/or leaking event, health and/or safety risks associated with a potentially undetectable flooding and/or leaking event, for example potential exposure to bacteria or mold, or rotting or erosive conditions, etc.).

### EXEMPLARY RESIDENTIAL SYSTEM ASSESSMENT

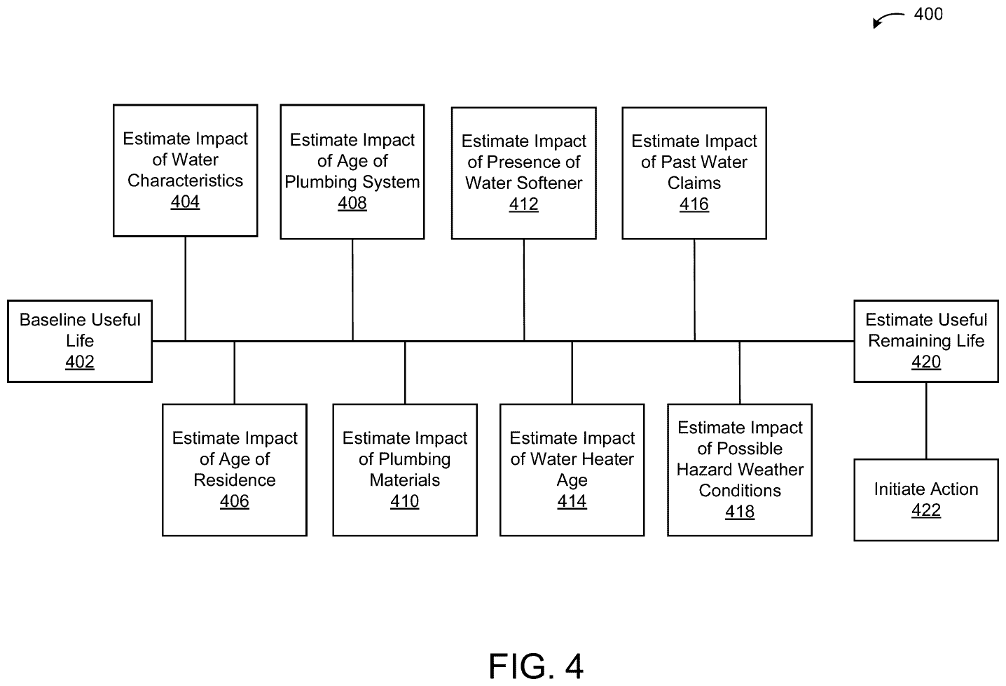

Referring now to FIG. 4, an illustrative example of a computer-implemented or computer-based process, shown as process 400 for initiating an action based upon an assessment of a remaining useful life of a system of a residential building is shown, according to some implementations. Process 400 may be implemented by any and/or all the components of the residential services system 100 of FIGS. 1-2 (e.g., the residential system 102, etc.). It should be appreciated that any and/or all the process 400 may be implemented by other systems, devices, and/or components (e.g., components of the residential services system 100, the residential system 102, etc.). It should be appreciated that in some embodiments, process 400 may be implemented using additional, different, and/or fewer operations, actions, and/or functionality.

In certain embodiments, the computer-implemented process 400 may include receiving and/or obtaining residential data. As described herein, the residential data may include, for example, user data, device data, third-party data, provider data, data from a computing system and/or a storage system, and/or any of the additional residential data and/or information described herein.

Computer-implemented process 400 may include determining a baseline useful life of a residential plumbing system (block 402), according to various embodiments. In some embodiments, a trained machine learning model is configured to use residential data to determine a baseline useful life of a residential system, subsystem, and/or component thereof. For example, using user data (e.g., a geolocation of a residential building, an address of a building, an age of a building, etc.) the trained machine learning model may determine a baseline useful life of a plumbing system of a residential building (e.g., a 50-year baseline lifespan for the plumbing system, etc.). The baseline useful life of the plumbing system may indicate an estimated or predicted lifetime of the plumbing system (e.g., in view of conditions when the plumbing system was constructed). In some implementations, the baseline useful life is based on historical data and/or information, for example historical data and/or information of similar systems, subsystems, and/or components thereof. For example, the baseline useful life may indicate a historical average, median, middle, etc. estimated or predicted lifetime of a plumbing system. In certain implementations, the baseline useful life is a lowest or minimum estimated lifetime, a highest or maximum estimated lifetime, and/or another suitable amount and/or measure of an estimated and/or predicted lifetime.

In certain implementations, the computer-implemented process 400 may include estimating the impact of one or more characteristics, qualities, and/or features associated with the residential data, as discussed herein, and as described below.

Computer-implemented process 400 may include estimating an impact of one or more water characteristics (block 404), according to some embodiments. In some implementations, the trained machine learning model may be configured to use residential data to determine an impact of the characteristics of the water supplied to the residential building on the baseline useful life of the residential plumbing system. For example, using third-party data (e.g., water characteristic data obtained from a water utility entity, for example including mineral levels and/or pH, etc.), the trained machine learning model may estimate an impact of the water on the baseline useful life of the residential plumbing system. For example, the water may include high mineral levels, and the trained machine learning model may estimate that the high mineral levels in the water may impact e.g., the baseline useful life of the residential plumbing system. As described herein, the trained machine learning model may estimate an impact of one or more characteristics, qualities, and/or features associated with the residential data (e.g., water characteristics, etc.), which may be used to initiate an action (e.g., generate a recommendation, etc.) that if implemented (e.g., followed, performed, etc.) may increase the remaining useful life of the residential system, subsystem, and/or component thereof and/or provide a benefit (e.g., a discount, a reward, a cost-savings, a cost reduction, etc.).

Computer-implemented process 400 may include estimating an impact of one or more residential building characteristics (blocks 406-408), according to various embodiments. In certain embodiments, the trained machine learning model may be configured to use residential data to determine an impact of the residential building characteristics on the baseline useful life of the residential plumbing system. In some embodiments, using user data (e.g., information relating to an age of the residential building, etc.), the trained machine learning model may estimate an impact of the age of the residence on the baseline useful life of the residential plumbing system (block 406). For example, the user data may indicate that the residence is over 20 years old, which the trained machine learning model may estimate impacts e.g., the baseline useful life of the residential plumbing system. Similarly, in certain implementations, using user data (e.g., information relating to an age of the plumbing components and/or materials, etc.), the trained machine learning model may estimate an impact of the age of the plumbing on the baseline useful life of the residential plumbing system (block 408). For example, the user data may indicate that the plumbing components are over 20 years old, which the trained machine learning model may estimate impacts e.g., the baseline useful life of the residential plumbing system.

Computer-implemented process 400 may include estimating an impact of one or more characteristics associated with the plumbing system (blocks 410-414), according to some embodiments. In various embodiments, the trained machine learning model may be configured to use residential data to determine an impact of the plumbing system characteristics on the baseline useful life of the residential plumbing system. In some embodiments, using user data and/or residential device data (e.g., information relating to material characteristics.), the trained machine learning model may estimate an impact of the materials used in the plumbing system on the baseline useful life of the residential plumbing system (block 410). For example, the data may indicate that the plumbing system utilizes PVC (e.g., in pipes, fittings, etc.), which the trained machine learning model may estimate impacts e.g., the baseline useful life of the residential plumbing system.

In certain embodiments, using user data and/or residential device data (e.g., using information relating to a configuration of the plumbing system, etc.), the trained machine learning model may estimate an impact of the characteristics of a water softener (block 412) and/or a water heater (block 414). For example, the data may indicate that the plumbing system does not include a water softener, which the trained machine learning model may estimate impacts e.g., the baseline useful life of the residential plumbing system. Further, the data may indicate that the plumbing system includes water heater that is over 3 years old and that it was last flushed over 1 year ago, which the trained machine learning model may estimate impacts e.g., the baseline useful life of the residential plumbing system.

Computer-implemented process 400 may include estimating an impact of one or more policy characteristics associated with the residential building (block 416), according to some implementations. In certain implementations, the trained machine learning model may be configured to use residential data to determine an impact of historical policy parameters and/or requests on the baseline useful life of the residential plumbing system. For example, the data may indicate that the residential building and/or the plumbing system has prior requests associated with repairs and/or maintenance to the plumbing system, which the trained machine learning model may estimate impacts e.g., the baseline useful life of the residential plumbing system.

Computer-implemented process 400 may include estimating an impact of one or more environmental characteristics associated with the residential building (block 418), according to various embodiments. In some embodiments, the trained machine learning model may be configured to use residential data to determine an impact of environmental conditions (e.g., weather, typical seasonal conditions, etc.) on the baseline useful life of the residential plumbing system. For example, the data may indicate that the residential building is in an environment and/or location where the residential building will be exposed to potential freezing or unfavorable weather conditions, or non-freezing or favorable weather conditions, which the trained machine learning model may estimate impacts e.g., the baseline useful life of the residential plumbing system.

Computer-implemented process 400 may include estimating a remaining useful life of the residential plumbing system (block 420), according to some embodiments. In certain embodiments, the trained machine learning model may be configured to analyze each of the impacts of the residential data sets (e.g., blocks 404-418), and use the impacts of each of the residential data sets to estimate (e.g., predict, generate, determine, etc.) a remaining useful life of the residential plumbing system. In certain implementations, the computer-implemented process 400 may include generating a residential plumbing impact score, for example indicating an estimated (e.g., predicted, generated, determined, etc.) remaining useful life of the residential plumbing system.

Computer-implemented process 400 may include initiating an action (block 422), according to various embodiments. For example, in response to estimating the remaining useful life of the residential plumbing system, a user interface may be generated that provides the estimated remaining useful life of the residential plumbing system and/or the residential plumbing impact score (e.g., to a user or operator, etc.), and/or the information may otherwise audibly and/or visually be provided, such as via a computing device, display screen, or voice bot. In some implementations, initiating the action may include providing a recommendation, for example a recommendation for increasing the estimated remaining useful life of the residential plumbing system and/or the residential plumbing impact score, and/or preventing or mitigating home damage. In some embodiments, the recommendation includes additional information associated with the recommendation (e.g., a proposed maintenance or service provider, a proposed maintenance or service window, a proposed cost or timeline associated with the proposed maintenance or service, etc.).

For example, the recommendation may include at least one of a recommended maintenance action, for example to provide preventative and/or mitigative maintenance to one or more components of the residential system (e.g., the residential plumbing system, etc.). For example, based on a characteristic of the plumbing system (e.g., material characteristics of the piping of the plumbing system, etc.) a recommendation to replace piping with PEX and/or copper (e.g., rather than PVC) may be provided, for example to prevent and/or mitigate potential future damage associated with the plumbing material. Similarly, in some implementations, based on one or more characteristics of a water heater (e.g., an indication that the water heater leaks and/or is over 3 years old, etc.) a recommendation to replace the water heater (e.g., rather than repair the water heater, etc.) may be provided, for example to prevent and/or mitigate potential additional and/or future damage associated with the functioning of the water heater. In certain implementations, based on one or more characteristics of the residential building and/or water characteristics (e.g., a faucet that leaks as a result of hard water, a dishwasher that is operating inefficiently as a result of hard water, etc.) a recommendation to add a water softener (e.g., rather than replacing the faucet or dishwasher, etc.) may be provided, for example to prevent and/or mitigative potential future or additional damage associated with the features of the building and/or water characteristics.

In certain embodiments, the recommended action may include additional recommended maintenance actions, for example to provide preventative and/or mitigative maintenance to one or more components of the plumbing system. For example, the recommended maintenance action may include, for example, a recommendation to flush a water heater (e.g., within a predetermined time period, etc.). In some implementations, the recommended maintenance action may include a component to add to the plumbing system, for example a recommendation to add a water softener to the residential plumbing system, to add a valve or gasket to a toilet in the plumbing system, etc. In certain implementations, the recommended maintenance action may include a component to replace in a plumbing system, for example a gasket, valve, and/or pipe within a toilet in the plumbing system, a dishwasher or washing machine connected to the plumbing system, a sump pump, etc. In some implementations, the recommended maintenance action may include a component to remove from the plumbing (e.g., a pressure or stop valve, etc.), and/or any other suitable recommendation (e.g., a recommendation to replace one or more of the PVC piping sections with PEX piping sections, a recommendation cease performing certain actions, such as running water or permitting water to overflow, etc.).

As described herein, in some embodiments the recommended maintenance action is one or more preventative and/or mitigative actions configured to improve the remaining useful life of one or more components of a plumbing system. For example, the recommended maintenance action may include one or more preventative and/or mitigative actions (e.g., a recommendation to flush a water heater, replace a toilet gasket, pipe, and/or valve, replace a dishwasher, etc.), which may be configured to increase an estimated remaining useful life of a sump pump of a residential plumbing system.

In some implementations, the recommendation may be generated based on additional information and/or data (e.g., user data, third-party data, etc.). For example, the recommendation may be generated based on a schedule or calendar associated with a user, information associated with a service provider and/or maintenance provider (e.g., location, reviews, availability, etc.), and/or other associated information (e.g., a budget, a repair timeline, etc.). In this regard, and as described elsewhere herein, in certain implementations the recommendation includes a proposed maintenance or service provider (e.g., a recommended provider based on third-party or user reviews, etc.), a proposed maintenance or service window (e.g., a recommended time or window where the user and/or the third-party is available to complete the maintenance and/or service based on their calendars and/or schedules, etc.), a proposed cost or timeline associated with the proposed maintenance or service (e.g., a proposed cost based on similar and/or historical maintenance or service events,), and/or other associated information.

In some embodiments, computer-implemented process 400 may include providing one or more policy parameters. For example, initiating the action may include providing information relating to one or more policy parameters (e.g., relating to the estimated useful life of the residential plumbing system, the residential plumbing impact score, and/or an associated recommendation, etc.). For example, as a potential benefit or reward to implementing a recommended maintenance action and/or modification, at least one policy parameter may be provided as a potential benefit to a user.

Further, as a potential benefit or reward to implementing a recommended maintenance action and/or modification, the preventative and/or mitigative action may reduce and/or prevent potential damage to and/or inefficient operating conditions of components of a residential plumbing system, thereby reducing resource consumption (e.g., water consumption associated with operating a damaged and/or inefficient component, resources associated with repairing/replacing damaged and/or inefficient components, etc.). Yet further, as a potential benefit or reward to implementing a recommended maintenance action and/or modification, the preventative and/or mitigative action may reduce potential health and/or safety risks associated with a potential failure and/or potential damage to the residential plumbing system (e.g., health and/or safety risks associated with a potential flooding and/or leaking event, health and/or safety risks associated with a potentially undetectable flooding and/or leaking event, for example potential exposure to bacteria or mold, or rotting or erosive conditions, etc.).

### Exemplary Residential Plumbing System Assessment

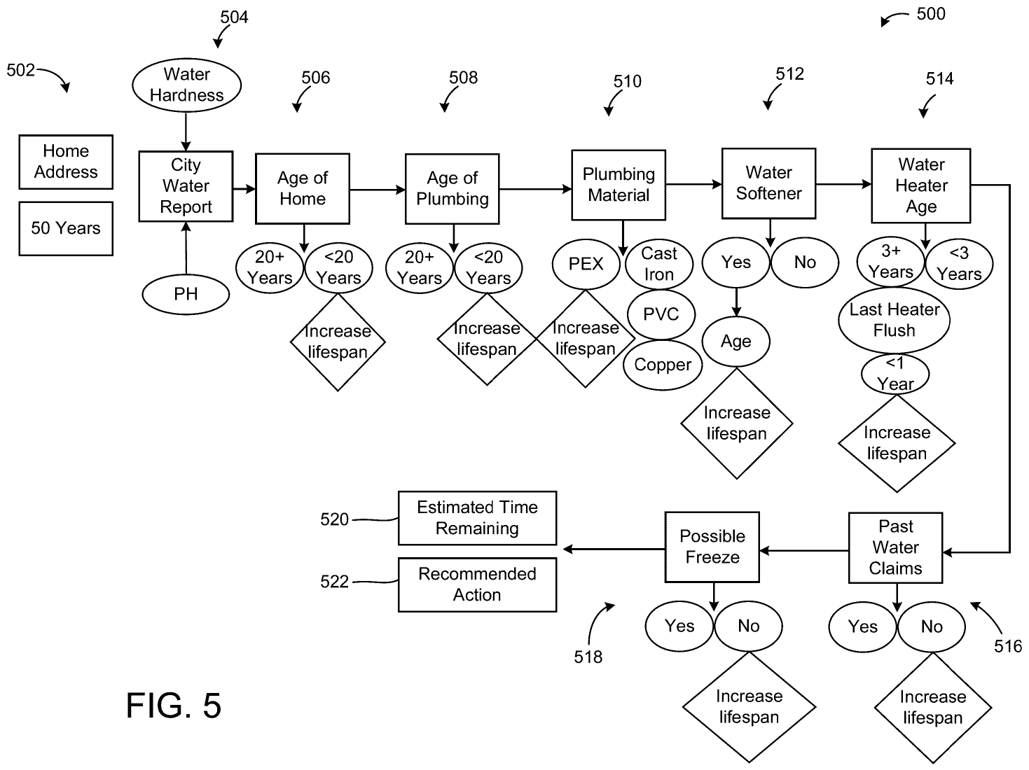

Referring now to FIG. 5, an illustrative example of a computer-implemented or computer-based process, shown as computer-implemented process 500 for initiating an action (e.g., a recommended maintenance or repair action, etc.) based upon an assessment of an estimated remaining life of a system of a residential building (e.g., a plumbing system) is shown, according to some embodiments. Process 500 may be a computer-implemented or computer-based process, which may be implemented by any and/or all the components of the residential services system 100 of FIGS. 1-2 (e.g., the residential system 102, etc.). It should be appreciated that any and/or all the process 500 may be implemented by other systems, devices, and/or components (e.g., components of the residential services system 100, the residential system 102, etc.). It should be appreciated that in certain embodiments, process 500 may be implemented using additional, different, and/or fewer operations, actions, and/or functionality.

In various embodiments, the computer-implemented process 500 may include receiving and/or obtaining residential data. As described herein, the residential data may include, for example, user data, device data, third-party data, provider data, data from a computing system and/or a storage system, and/or any of the additional residential data and/or information described herein.

Computer-implemented process 500 may include determining a baseline life of a plumbing system (block 502), according to some embodiments. In certain implementations, a trained machine learning model is configured to use residential data to determine a baseline useful life of the plumbing system of a home. For example, using user data (e.g., an address of a home, etc.) the trained machine learning model may determine a baseline useful life of a plumbing system of the home (e.g., a 50-year baseline lifespan for the plumbing system, etc.). The baseline useful life of the plumbing system may indicate an estimated or predicted lifetime of the plumbing system, as described herein.

The baseline useful life of the plumbing system may indicate an estimated or predicted lifetime of the plumbing system (e.g., in view of conditions when the plumbing system was constructed). In some implementations, the baseline useful life is based on historical data and/or information, for example historical data and/or information of similar systems, subsystems, and/or components thereof. For example, the baseline useful life may indicate a historical average, median, middle, etc. estimated or predicted lifetime of a plumbing system. In certain implementations, the baseline useful life is a lowest or minimum estimated lifetime, a highest or maximum estimated lifetime, and/or another suitable amount and/or measure of an estimated and/or predicted lifetime.

In some implementations, the computer-implemented process 500 may include estimating the impact of one or more characteristics, qualities, and/or features associated with the residential data, as discussed herein, and as described below. For example, computer-implemented process 500 may include estimating an impact of one or more water characteristics (block 504), according to some embodiments. Using third-party data (e.g., water characteristic data obtained from a city water report, for example including a water hardness or mineral level and/or PH level, etc.), the trained machine learning model may estimate an impact of the water on the baseline useful life of the plumbing system. For example, the water may include high mineral levels (e.g., a high-water hardness level, etc.), and the trained machine learning model may estimate that the high mineral levels in the water may impact e.g., the baseline useful life of the plumbing system. As described herein, the trained machine learning model may estimate an impact of one or more characteristics, qualities, and/or features associated with the residential data (e.g., water characteristics, etc.), which may be used to initiate an action (e.g., generate a recommendation, etc.) that if implemented (e.g., followed, performed, etc.) may increase the remaining useful life of the plumbing system and/or provide a benefit (e.g., a discount, a reward, a cost-savings, a cost reduction, etc.).

The computer-implemented process 500 may also include estimating an impact of one or more residential building characteristics (blocks 506-508), according to various embodiments. In some embodiments, using user data (e.g., an age of the home, etc.), the trained machine learning model may estimate an impact of the age of the home on the baseline useful life of the plumbing system (block 506). For example, the user data may indicate that the home is less than 20 years old, which the trained machine learning model may estimate impacts e.g., the baseline useful life of the plumbing system (e.g., increases or improves the baseline useful life of the plumbing system, does not affect or harm the baseline useful life of the plumbing system, etc.). Similarly, in certain embodiments, using user data (e.g., an age of the plumbing components of the plumbing system, etc.), the trained machine learning model may estimate an impact of the age of the plumbing on the baseline useful life of the plumbing system (block 508). For example, the user data may indicate that the plumbing components are less than 20 years old, which the trained machine learning model may estimate impacts e.g., the baseline useful life of the plumbing system (e.g., increases or improves the baseline useful life of the plumbing system, does not affect or harm the baseline useful life of the plumbing system, etc.).

Computer-implemented process 500 may further include estimating an impact of one or more characteristics associated with the plumbing system (blocks 510-514), according to some embodiments. Using user data and/or residential device data (e.g., information relating to material characteristics, configurations and/or components of the plumbing system, etc.), the trained machine learning model may estimate an impact of the materials used in the plumbing system on the baseline useful life of the plumbing system (block 510). For example, the data may indicate that the plumbing system utilizes PEX (e.g., in pipes, fittings, etc.), which the trained machine learning model may estimate impacts (e.g., negatively or positively) the baseline useful life of the plumbing system (e.g., increases or improves the baseline useful life of the plumbing system, does not affect or harm the baseline useful life of the plumbing system, etc.).

In certain implementations, using user data and/or residential device data (e.g., information relating to a configuration of the plumbing system, etc.), the trained machine learning model may also estimate an impact of a water softener (block 512) and/or a water heater (block 514). For example, the data may indicate that the plumbing system includes a water softener, which the trained machine learning model may estimate impacts e.g., the baseline useful life of the plumbing system (e.g., increases or improves the baseline useful life of the plumbing system, does not affect or harm the baseline useful life of the plumbing system, etc.). Further, the data may indicate that the plumbing system includes water heater that is less than 3 years old, which the trained machine learning model may estimate impacts e.g., the baseline useful life of the plumbing system (e.g., increases or improves the baseline useful life of the plumbing system, does not affect or harm the baseline useful life of the plumbing system, etc.). In some implementations, the data may indicate that the plumbing system includes a water heater that was last flushed less than 1 year ago, which the trained machine learning model may estimate impacts the baseline useful life of the plumbing system (e.g., increases or improves the baseline useful life, etc.).

Computer-implemented process 500 may include estimating an impact of one or more policy characteristics associated with the home and/or the plumbing system (block 516), according to various embodiments. For example, the data may indicate that the home and/or the plumbing system has no prior requests associated with repairs and/or maintenance to the plumbing system (e.g., past requests associated with a water system, etc.), which the trained machine learning model may estimate impacts e.g., the baseline useful life of the plumbing system (e.g., increases or improves the baseline useful life of the plumbing system, does not affect or harm the baseline useful life of the plumbing system, etc.).

Computer-implemented process 500 may include estimating an impact of one or more environmental characteristics associated with the home (block 518), according to some implementations. In some embodiments, the trained machine learning model may be configured to use residential data to determine an impact of environmental conditions (e.g., seasonal conditions, including whether the home is susceptible to a possible freezing event or is exposed to more favorable weather conditions in which freezing events are unlikely, etc.) on the useful life of the plumbing system. For example, the data may indicate that the home is in an environment and/or location where the home will not be exposed to potential freezing or non-freezing conditions, which the trained machine learning model may estimate impacts e.g., the baseline useful life of the plumbing system (e.g., increases or improves the baseline useful life of the plumbing system, does not affect or harm the baseline useful life of the plumbing system, etc.).

Computer-implemented process 500 may include estimating a useful remaining life of the plumbing system (block 520), according to certain embodiments. In some embodiments, the trained machine learning model may be configured to analyze each of the impacts of the residential data sets (e.g., blocks 504-518), and use the impacts of each of the residential data sets to estimate (e.g., predict, generate, determine, etc.) a remaining useful life of the plumbing system. In various embodiments, the process 500 includes generating a residential plumbing impact score, for example indicating an estimated (e.g., predicted, generated, determined, etc.) remaining useful life of the residential plumbing system.

Computer-implemented process 500 may include providing a recommendation (block 522), according to some embodiments. The recommendation may include a recommendation for increasing an estimated remaining useful life of the plumbing system (and/or a plumbing impact score). As described herein, the recommendation may include at least one of a recommended preventative and/or mitigative maintenance action. For example, the recommendation may include a recommendation to replace piping with PEX and/or copper (e.g., rather than PVC), for example to prevent and/or mitigate potential future damage associated with the plumbing material, and/or a recommendation to replace a water heater (e.g., rather than repair the water heater, etc.), for example to prevent and/or mitigate potential additional and/or future damage associated with the functioning of the water heater, as described herein. In certain implementations, the recommendation may include a recommendation to add a water softener (e.g., rather than replacing a faucet or a dishwasher, etc.), for example to prevent and/or mitigative potential future or additional damage associated with the features of the building and/or water characteristics, as also described herein. In some implementations, the recommendation includes another suitable preventative and/or mitigative action, for example a maintenance action (e.g., flush the hot water heater, etc.), a component to add to the plumbing system (e.g., a water softener, etc.), a component to remove from the plumbing (e.g., a pressure or stop valve, etc.), a component to replace in a plumbing system (e.g., one or more of the PVC piping sections with PEX piping sections, etc.), and/or any other suitable recommendation (e.g., a recommendation to cease performing certain actions, such as running water or permitting water to overflow, etc.).

In some implementations, the recommendation may be generated based on additional information and/or data (e.g., user data, third-party data, etc.). For example, the recommendation may be generated based on a schedule or calendar associated with a user, information associated with a service provider and/or maintenance provider (e.g., location, reviews, availability, etc.), and/or other associated information (e.g., a budget, a repair timeline, etc.). In this regard, and as described elsewhere herein, in certain implementations the recommendation includes a proposed maintenance or service provider (e.g., a recommended provider based on third-party or user reviews, etc.), a proposed maintenance or service window (e.g., a recommended time or window where the user and/or the third-party is available to complete the maintenance and/or service based on their calendars and/or schedules, etc.), a proposed cost or timeline associated with the proposed maintenance or service (e.g., a proposed cost based on similar and/or historical maintenance or service events,), and/or other associated information.

In some implementations, process 500 includes initiating one or more additional actions. For example, in response to estimating the remaining useful life of the plumbing system, a user interface may be generated that provides the estimated remaining useful life of the plumbing system and/or a plumbing impact score (e.g., to a user or operator, etc.), and/or the information may otherwise audibly and/or visually be provided, such as via a computing device, display screen, or voice bot.

In certain embodiments, the process 500 may include providing one or more policy parameters. For example, initiating the action may include providing information relating to one or more policy parameters (e.g., relating to the estimated useful life of the plumbing system, the plumbing impact score, and/or an associated recommendation, etc.). For example, as a potential benefit or reward to implementing a recommended maintenance action and/or modification, at least one policy parameter may be provided as a potential benefit to a user.

Further, as a potential benefit or reward to implementing a recommended maintenance action and/or modification, the preventative action may reduce, mitigate, and/or prevent potential damage to and/or inefficient operating conditions of components of the plumbing system, thereby reducing resource consumption (e.g., water consumption associated with operating a damaged and/or inefficient component, resources associated with repairing/replacing damaged and/or inefficient components, etc.). Yet further, as a potential benefit or reward to implementing a recommended maintenance action and/or modification, the preventative and/or mitigative action may reduce potential health and/or safety risks associated with a potential failure, and/or potential or actual damage to the plumbing system (e.g., health and/or safety risks associated with a potential flooding and/or leaking event, health and/or safety risks associated with a potentially undetectable flooding and/or leaking event, for example potential exposure to bacteria or mold, or rotting or erosive conditions, etc.).

### Exemplary Plumbing System Evaluation

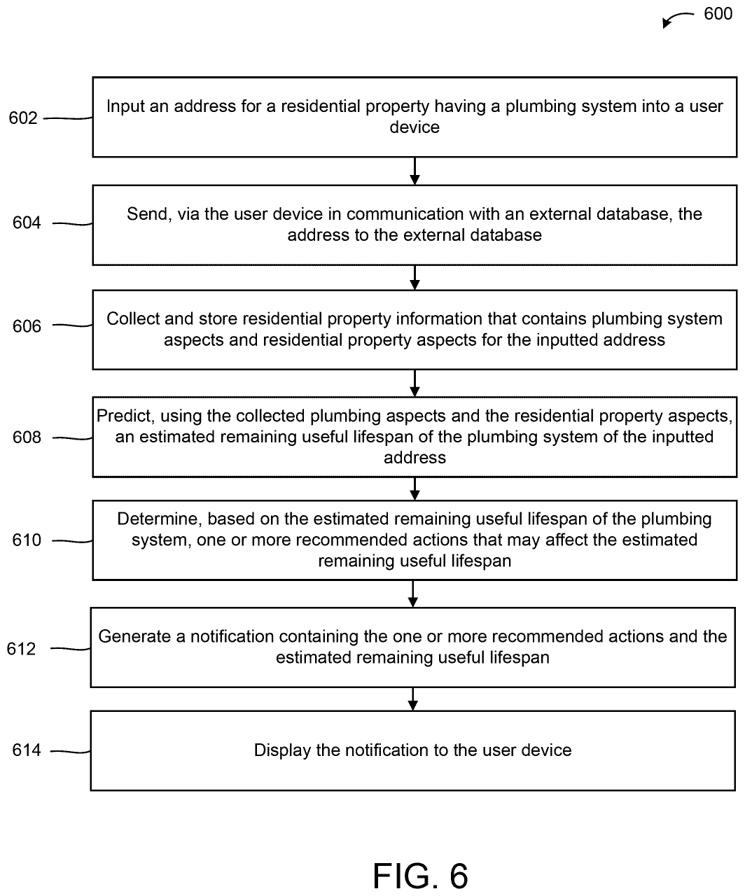

Referring to FIG. 6, depicted is a block diagram of an example computer-implemented method 600 of evaluating aspects of a plumbing system. The computer-based method 600 may be facilitated by an electronic device that may be a user or mobile device, and/or implemented via one or more local or remote processors, servers, sensors, transceivers, memory units, wearables, smart watches, VR headsets, AR glasses, mobile devices, smart home controllers, smart vehicles, and/or other electronic or electric components, including those discussed herein.

The computer-implemented method 600 may include inputting an address for a residential property into the user device (block 602), according to some embodiments. In some implementations, the computer-implemented method 600 may include receiving (e.g., via an interface, via an interaction with a user device, etc.) an input. For example, in some implementations a device (e.g., a user device, a computing device, etc.) is configured to receive an input, for example from a user or operator. In certain embodiments, a device (e.g., a residential system, a computing system, etc.) is configured to receive an input, for example from another device (e.g., a user device, an edge device, etc.), as described herein. In certain implementations, the input may be indicative of an address, for example an address of a property (e.g., a residential property, a residential building, etc.). The inputted address may be an address within a geographic area. In certain implementations, the input may further include a plumbing system indicator or indication, including, for example, an indication of a water softener being present within the residential property, a water heater age of a water heater present in the residential property, a past water claim, and/or any other suitable plumbing system information, as described herein.

The computer-implemented method 600 may include communicably coupling the input device to an external database capable of containing residential property information, including residential property information for the inputted address (block 604), according to some embodiments. In some implementations, the computer-implemented method 600 may include communicating with another device (e.g., a database, a computing system, a residential system, a third-party system, a storage system, etc.), for example a device containing information associated with one or more geolocations (e.g., a database comprising residential records associated with different geolocations or addresses, etc.). For example, a user device and/or system (e.g., a residential system, a server, etc.) may be configured to communicate with another device (e.g., an external storage system, an external database, etc.), for example to communicably couple the user device and/or system and the other device. In some implementations, the communications include the address. For example, the user device and/or system (e.g., residential system, etc.) may be configured to communicate with the inputted address to an external storage system (e.g., database, etc.) containing information associated with the address (e.g., residential records, historic residential data, etc.), as described herein.

The computer-implemented method 600 may include collecting, receiving, retrieving, and/or generating the residential property information, which may be stored in one or more memory devices (block 606), according to some embodiments. The residential property information may include plumping system or residential property aspects such as: geographic location, neighborhood, size (e.g., square footage), price range, structural design, year of build, number of rooms, piping data, plumbing system data, plumbing data, etc. The external database may be in communication with sensors providing plumbing or piping data for a plumbing system. The sensors may be house-mounted sensors or remote sensors. The residential property information may include an input from the user via the user device. The collected residential property information may be representative of historical and/or current conditions for the residential property.

In some implementations, the computer-implemented method 600 includes obtaining the residential property information. For example, the computer-implemented method 600 may include obtaining (e.g., receiving, retrieving, calling, requesting, determining, identifying, extracting, etc.) residential property information associated with the address (e.g., using the residential property information, the residential data, etc.), which may include, for example, plumbing system aspects (e.g., information, characteristics, etc.) and/or residential property aspects (e.g., information, characteristics, etc.), as described herein. In certain implementations, the residential property information is obtained by a user device, a computing system or device (e.g., a residential system, etc.), a provider or third-party system, a storage system, and/or any other suitable system or device described herein. In some implementations, the computer-implemented method 600 includes obtaining (e.g., extracting, retrieving, calling, etc.) the residential property information and/or storing the residential property information, for example for subsequent analysis, processing, and/or evaluation.

In certain implementations, the residential property information associated with the address may include temperature data associated with the geographic location (e.g., the address). Further, and as described elsewhere herein, in some implementations the plumbing system aspects include one or more of a plumbing material (e.g., cast iron, PEX, PVC, copper, etc.), a plumbing system age (e.g., indicative of a number of years the plumbing system has been in service, etc.), and/or other suitable information associated with the plumbing system. The residential property aspects may include, for example, a city water report (e.g., including a PH level, a water hardness measurement, etc.), an age of the residential property, and/or any other suitable residential property data.

The computer-implemented method 600 may include the collected residential property information may be used in the generation of an estimated remaining life of the plumbing system for the residential property (block 608), according to some embodiments. The plumbing system aspects and the residential property aspects may be used to predict changes in the plumbing system within the residential property over a specified period of time. The estimated remaining life may be predicted through the use of collected residential property information representing historical and/or current conditions to enhance the usefulness of the predicted remaining life.

In some implementations, the computer-implemented method 600 may include estimating (e.g., predicting, determining, identifying, etc.) an estimated remaining lifespan or estimated remaining useful life of a system associated with the address. For example, the computer-implemented method 600 may include estimating a remaining lifespan or remaining useful life of a plumbing system associated with the address, for example using the plumbing system aspects and/or the residential aspects, as described herein. In certain implementations, the computer-implemented method 600 may include obtaining (e.g., receiving, retrieving, calling, requesting, determining, identifying, etc.) an estimated remaining lifespan or remaining useful life of a system (e.g., a subsystem or system associated with the address, a plumbing system associated with the address, etc.). For example, a user device, a computing system, and/or another suitable device and/or system described herein (e.g., a residential system, an edge device, etc.) may be configured to obtain information associated with an estimated remaining lifespan or remaining useful life of a system (e.g., a plumbing system associated with the address), as described herein.

The computer-implemented method 600 may use the predicted remaining life of the plumbing system to determine one or more recommended actions intended to affect or change the predicted remaining life (block 612), according to some embodiments. The one or more recommended actions may include actions that mitigate, prevent, or detect home damage. The recommended actions may include corrective actions directed to one or more plumbing system aspects and/or residential property aspects. In determining the one or more recommended actions, the computer-implemented method 600 may predict how the one or more recommended actions may affect the estimated remaining life.

In some implementations, the computer-implemented method 600 may include initiating one or more actions, for example based upon and/or using the estimated remaining useful lifespan. For example, the computer-implemented method 600 may include generating a notification including the estimated remaining lifespan of the system (e.g., a plumbing system associated with the address). The notification may also include one or more recommended actions, which, for example, if implemented may mitigate, prevent, and/or detect home damage, thereby affecting (e.g., increase, improve, enhance, etc.) the estimated remaining lifespan. In some implementations, the computer-implemented method 600 may include obtaining (e.g., receiving, retrieving, requesting, calling, etc.) a notification including, for example, the estimated remaining lifespan and/or one or more recommended actions, as described herein.

By determining how one or more recommended actions will affect (e.g., increase) the estimated remaining life, the computer-implemented method 600 may communicate those actions to the user device (block 612), according to some embodiments. As described herein, the computer-implemented method 600 may generate a notification including at least: the estimated remaining life of the plumbing system and one or more recommended actions. In some embodiments, the notification may include an updated estimated remaining life following the execution of one or more of the recommended actions. In some implementations, the computer-implemented method 600 may include obtaining (e.g., receiving, retrieving, requesting, calling, etc.) the notification including, for example, the estimated remaining lifespan (e.g., of the plumbing system, etc.) and/or one or more recommended actions (e.g., a recommended action to mitigate, prevent, and/or detect damage or potential damage, etc.), as described herein.

The computer-implemented method 600 may include presenting the notification to the user, such as via the user device (block 614), according to some embodiments. For instance, the generated notification may be displayed to the user via the use device for review. Additionally or alternatively, the generated notification may be audibly or verbally presented to the user, such as via a chatbot or voice bot operating or installed on the user device. The method may include additional, less, or alternate functionality, including that discussed elsewhere herein.

In some implementations, the notification includes instructions to provide (e.g., display, present, etc.) the notification. For example, the notification may include instructions to display (e.g., present, populate, generate, etc.) the notification via a user interface, for example for the user to view and/or assess the information (e.g., the estimated remaining lifespan, the one or more recommended actions, etc.). In some implementations, the computer-implemented method 600 may include obtaining the notification and/or causing the notification to be displayed (e.g., via a user interface, via an interface, via a display of a device, via instructions provided along with the notification to present a display including the notification, etc.).

In certain implementations, the computer-implemented method 600 further includes generating a modification factor for a system, according to some embodiments. For example, the computer-implemented method 600 may include generating a lifespan modification factor, for example based upon an affect the one or more recommended actions has on the plumbing system (e.g., the estimated remaining lifespan, the estimated remaining useful life, etc. associated with the plumbing system). In some implementations, and as described herein, the lifespan modification factor may be indicative of an effect the one or more recommended actions has to the estimated remaining lifespan of the plumbing system.

In some implementations, the computer-implemented method 600 further includes receiving an input. For example, the computer-implemented method 600 may include receiving an updated input (e.g., from a user, from a user device, etc.), for example indicating that the one or more recommended actions have been implemented (e.g., initiated, started, completed, etc.). In certain implementations, the computer-implemented method 600 further includes generating a notification. For example, the computer-implemented method 600 may include generating an updated notification, which may include an updated estimated remaining lifespan or remaining useful life and/or one or more recommended actions (e.g., one or more additional recommended actions, one or more supplemental recommended actions, etc.). In certain implementations, the computer-implemented method 600 may also include initiating one or more actions. For example, the computer-implemented method 600 may include providing an instruction to display the updated notification (e.g., an instruction to display the updated notification via a user device), for example to present the updated notification via a display (e.g., on the display). In this regard, in some implementations the computer-implemented method 600 may include displaying the updated notification to a user (e.g., via the user device, via a display of the user device, etc.), for example to allow a user to assess and/or implement one or more actions associated with the updated notification, as discussed herein.

### Exemplary Plumbing System Evaluation

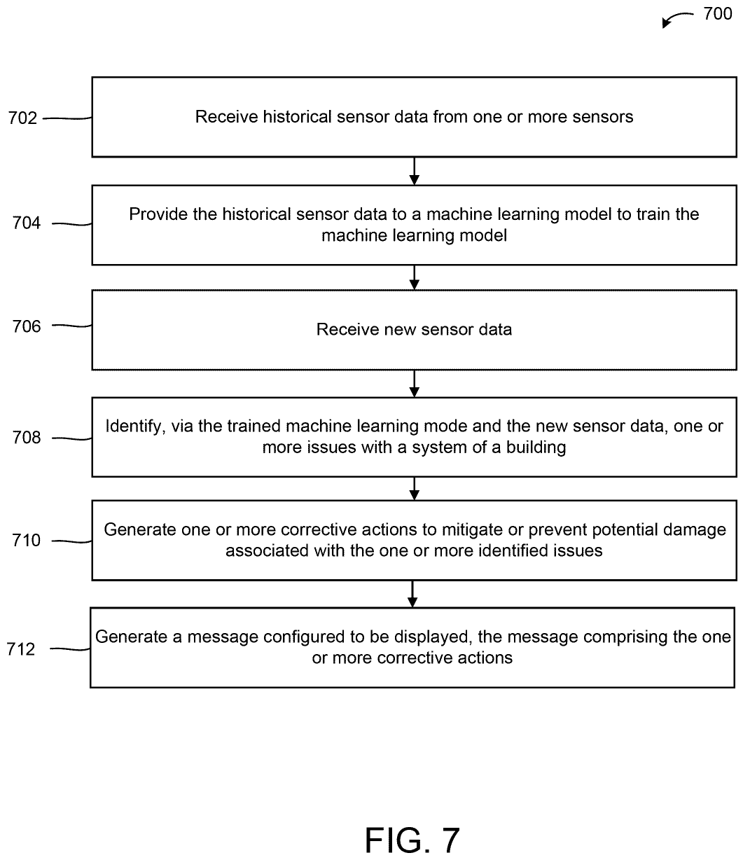

Referring to FIG. 7, depicted is a block diagram of an example computer-implemented method 700 of evaluating aspects of a plumbing system (e.g., identifying a plumbing issue, etc.). The computer-based method 700 may be facilitated by an electronic device that may be a user or mobile device, and/or implemented via one or more local or remote processors, servers, sensors, transceivers, memory units, wearables, smart watches, VR headsets, AR glasses, mobile devices, smart home controllers, smart vehicles, and/or other electronic or electric components, including those discussed herein.

The computer-implemented method 700 may include receiving sensor data from one or more sensors (block 702), according to some embodiments. In some implementations, the computer-implemented method 700 may include receiving historical sensor data (e.g., via the one or more sensors, etc.). The historical sensor data may include, for example, photo data, video data, audio data, smart home data, vehicle data, mobile device data, and/or any other suitable data described herein. In some implementations, the historical sensor data is associated with plumbing data, piping data, and/or any other suitable data described herein. In certain implementations, the historical sensor data includes, for example, property information associated with an address (e.g., temperature data associated with a geographic location, etc.), plumbing material information (e.g., cast iron, PEX, PVC, copper, etc.), a plumbing system age (e.g., indicative of a number of years the plumbing system has been in service, etc.), and/or other suitable information associated with a plumbing system. In some embodiments, the one or more sensors are stationary sensors (e.g., a home-mounted sensor, a device-mounted sensor, etc.). In certain implementations, the sensor data is configured to be received in real-time, and/or at any suitable interval (e.g., every minute, every hour, every day, etc.).

In some embodiments, the computer-implemented method 700 may include receiving residential property information. The residential property information may include plumping system or residential property aspects such as: geographic location, neighborhood, size (e.g., square footage), price range, structural design, year of build, number of rooms, piping data, plumbing system data, plumbing data, etc., and/or any other suitable information or data described herein. In certain implementations, the residential property information includes, for example, a city water report (e.g., including a PH level, a water hardness measurement, etc.), an age of the residential property, and/or any other suitable residential property data. In some implementations, the residential property information includes, for example, an indication of a water softener being present within a residential property, a water heater age of a water heater present in the residential property, a past water claim, and/or any other suitable plumbing system information, as described herein.

The computer-implemented method 700 may include providing the sensor data to a machine learning model (block 704), according to certain embodiments. In certain implementations, the computer-implemented method 700 may include providing the historical sensor data to the machine learning model. In some embodiments, the historical sensor data is provided to the machine learning model to train the machine learning model. For example, the historical sensor data may be provided to the machine learning model to train the machine learning model to identify a current plumbing issue, a current piping issue, and/or another suitable issue described herein. In some implementations, the machine learning model is trained to predict a future plumbing issue, a future piping issue, and/or another suitable future issue described herein. In certain implementations, the machine learning model is a predictive model. In certain implementations, the machine learning model is a generative artificial intelligence model, a generative machine learning model, and/or another suitable model described herein.

The computer-implemented method 700 may include receiving sensor data (block 706), according to some embodiments. In some implementations, the sensor data is new sensor data, for example received from the one or mor sensors. The new sensor data may include new plumbing data, new piping sensor data, and/or any other suitable data described herein. In some embodiments, the new sensor data includes, for example, photo data, video data, audio data, smart home data, vehicle data, mobile device data, and/or any other suitable data described herein.

The computer-implemented method 700 may include identifying one or more issues of a system of a building (block 708), according to some embodiments. In some implementations, the computer-implemented method 700 includes identifying one or more issues via the machine learning model (e.g., the trained machine learning model, etc.) and/or the new sensor data (e.g., the new plumbing data, the new piping sensor data, etc.). In certain embodiments, the one or more issues is/are associated with a system of a building. For example, the one or more issues may be associated with a piping system of a building, a plumbing system of a building, and/or another suitable system, subsystem, and/or component or device of a building.

The computer-implemented method 700 may include generating one or more corrective actions to mitigate or prevent potential damage associated with the one or more identified issues (block 710), according to some embodiments. In some implementations, the computer-implemented method 700 may include generating the one or more corrective actions, for example, based upon the one or more current or future issues. As described elsewhere herein, the one or more corrective actions may include actions that, if implemented may mitigate, prevent, and/or detect damage (e.g., associated with a home or residential building, etc.). For example, the one or more corrective actions may include corrective actions directed to one or more plumbing system aspects and/or residential property aspects. In determining the one or more corrective actions, the computer-implemented method 700 may predict how the one or more corrective actions may affect an estimated remaining life, as described herein.

The computer-implemented method 700 may include generating a message configured to be displayed (block 712), according to some embodiments. In some implementations, the computer-implemented method 700 may include generating a message that includes the one or more corrective actions. As described herein, the one or more corrective actions may be associated with at least one of one or more current plumbing issues, one or more current piping issues, one or more future plumbing issues, one or more future piping issues, and/or any other suitable current, future, and/or potential issue described herein.

In some implementations, the computer-implemented method 700 includes causing the message to be displayed. For example, the computer-implemented method 700 may include transmitting the message to a device (e.g., a mobile device, a user device, etc.), for example to present the message via the mobile device (e.g., via a display screen of the mobile device, via a voice assistance component of the mobile device, etc.). In some implementations, the computer-implemented method 700 may include presenting the message to a user, for example via a user device. Additionally or alternatively, the message may be audibly or verbally presented to the user, such as via a chatbot or voice bot operating or installed on the user device. The method may include additional, less, or alternate functionality, including that discussed elsewhere herein.

In some implementations, the computer-implemented method 700 also includes generating a modification factor, as described herein. For example, the computer-implemented method 700 may include generating a lifespan modification factor, for example based upon an affect the one or more corrective actions has on a system (e.g., an estimated remaining lifespan, an estimated remaining useful life, etc. associated with a plumbing system). In certain implementations, the computer-implemented method 700 may include receiving an updated input (e.g., from a user, from a user device, etc.), for example indicating that the one or more corrective actions has/have been implemented (e.g., initiated, started, completed, etc.). In some embodiments, the computer-implemented method 700 further includes generating a notification, for example an updated message, which may include one or more corrective actions (e.g., one or more additional corrective actions, one or more supplemental recommended actions, etc.). In this regard, in some implementations the computer-implemented method 700 may include providing the updated notification to a user (e.g., via the user device, via a display of the user device, etc.), for example to allow a user to assess and/or implement one or more actions associated with the updated message, as discussed herein.

### Exemplary User Interface Displaying Recommendation

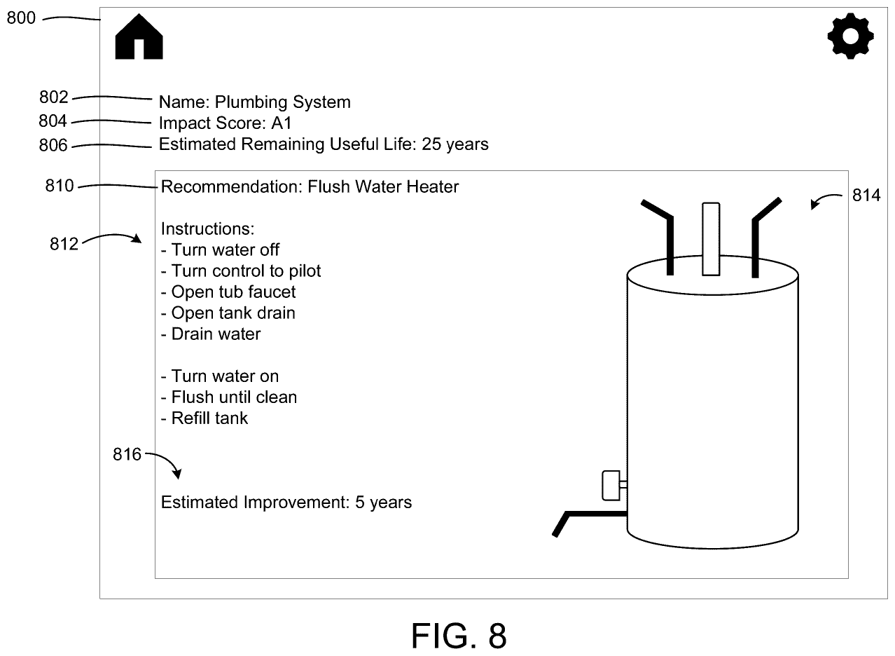

Referring to FIG. 8, a computer-generated user interface, shown as user interface 800, is shown, according to some embodiments. The computer-generated user interface 800 may be generated by any and/or all the components of the residential services system 100 of FIGS. 1-2 (e.g., the residential system 102, etc.). It should be appreciated that any and/or all the user interface 800 may be implemented by other systems, devices, and/or components (e.g., components of the residential services system 100, the residential system 102, etc.). It should be appreciated that in certain embodiments, user interface 800 may be implemented using additional, different, and/or fewer operations, actions, and/or functionality.

As shown in FIG. 7, the computer-generated user interface 800 may include a system or subsystem identifier (item 802), an impact score identifier (item 804), and an estimated remaining useful life identifier (item 806). In some embodiments, the system or subsystem identifier (the item 802) identifies a system, subsystem, and/or a component thereof, for example which a user or operator desires to know an impact score and/or an estimated remaining useful life of. In certain implementations, and as described herein, the computer-generated user interface 800 may include the impact score identifier (item 804), which illustrates an impact score associated with the system, subsystem, and/or component thereof (e.g., a residential impact score, a residential plumbing impact score, etc.). In some implementations, and as described herein, the computer-generated user interface 800 may include the estimated remaining useful life identifier (item 806), which illustrates an estimated remaining useful life of the system, subsystem, and/or component thereof.

In some embodiments, the computer-generated user interface 800 may also include an action or recommendation indicator (item 810), one or more instruction indicators (item 812), one or more diagrams (item 814), and/or an estimated improvement indicator (item 816). In some embodiments, the action or recommendation indicator (item 810) illustrates a recommended action (e.g., a maintenance action, a recommended component to add/remove/replace within the system or subsystem, etc.), for example to increase or improve the estimated remaining useful life of the system, subsystem, and/or component thereof.

In certain embodiments, the computer-generated user interface 800 includes the one or more instruction indicators (item 812). The one or more instruction indicators may include one or more instructions for implementing (e.g., performing, carrying out, etc.) the recommended action. In certain implementations, the computer-generated user interface 800 includes the one or more diagrams (item 814), which may include one or more images and/or diagrams for implementing (e.g., performing, carrying out, etc.) the recommended actions. In some embodiments, the computer-generated user interface 800 includes an estimated improvement indicator (item 816). The estimated improvement indicator (item 816) may indicate an estimated improvement in the remaining useful life of the system, subsystem, and/or component thereof, for example based upon implementing (e.g., performing, carrying out, etc.) the recommended action.

In some embodiments, the improvement indicator (item 816) includes additional and/or different components. For example, in some implementations the improvement indicator (item 816) includes one or more policy parameters, for example as a benefit for implementing the recommended action (e.g., a discount, a reward, a cost-savings, a cost reduction, an increase or expansion in coverage, an increase in duration of coverage of a policy, etc.). In some implementations, the computer-generated user interface 800 includes additional, fewer, and/or different components and/or features.

### EXEMPLARY EMBODIMENTS

A computer-implemented method for evaluating aspects of a plumbing system of a residential property using at least one processor in communication with at least one memory device of a user device may be provided. The computer-implemented method comprising, via one or more local or remote processors, servers, transceivers, memory unit, sensors, and/or other electronic or electric components: (1) receiving via the user device, a user input indicative of an address for the residential property; (2) communicating the address with an external database, the external database containing a plurality of residential records associated to the address in a geographic location; (3) determining or retrieving via one or more processors from the plurality of residential records a plurality of plumbing system aspects and a plurality of residential property aspects; (4) extracting, from the external database, the plurality of residential records and storing the plurality of residential within the memory device; (5) predicting an estimated remaining lifespan of the plumbing system based upon the plurality of plumbing system aspects and plurality of residential property aspects; (6) generating a notification, the notification comprising the estimated remaining lifespan of the plumbing system and one or more recommended actions; and/or (7) displaying the notification on the user device, such as by transmitting the notification to the user device (if the notification is generated remotely) and/or displaying the notification on the user device to facilitate providing estimated remaining lifespan information and/or associated recommendations to a user. The method may include additional, less, or alternate functionality, including that discussed elsewhere herein.

For instance, the plurality of plumbing system aspects may include at least one or more of: a plumbing material, the plumbing material further comprising: cast iron, pex, pvc, or copper; and/or a plumbing system age, wherein the plumbing system age is indicative of a number of years the plumbing system has been in service. The residential records associated with the address in the geographic location may include temperature data for the geographic location. The plurality of residential property aspects may include a city water report, the city water report indicating at least one of: a PH level and a water hardness for the address; and/or an age of the residential property.

The user input may include a plumbing system indication for the residential property, the plumbing system indication being indicative of a water softener being present within the residential property; a water heater age of a water heater present within the residential property; or a past water claim.

The computer-implemented method may include one or more local or remote processors, sensors, transceivers, servers, memory units, and/or other electronic or electric components: (i) generating a lifespan modification factor based upon the one or more recommended actions has on the plumbing system, wherein the lifespan modification factor is indicative of an effect the one or more recommended actions has to the estimated remaining lifespan of the plumbing system; (ii) receiving an updated user input from the user, the updated user input indicating that the one or more recommended actions were completed by the user; (iii) generating an updated remaining lifespan based upon the lifespan modification factor and the estimated remaining lifespan; (iv) generating an updated notification, the updated notification comprising the updated remaining lifespan and one or more additional recommended actions; and/or (v) displaying the updated notification on the user device, such as presenting the updated notification on a display of the user device.

In another aspect, a plumbing life detector device for evaluating aspects of a plumbing system of a residential property may be provided. The plumbing life detector device may include one or more local or remote processors, servers, sensors, transceivers, and/or other electronic or electric components (including those discussed elsewhere herein); one or more memories comprising executable instructions that, when executed by the one or more processors, cause the one or more processors to: (i) receive a user input via a user device indicative of an address for the residential property; (ii) send the address to an external database, the external database containing a plurality of residential records associated to the address in a geographic location; (iii) determine via one or more processors from the plurality of residential records a plurality of plumbing system aspects and a plurality of residential property aspects associated with the address; (iv) extract the plurality of plumbing system aspects and plurality of residential property aspects from the plurality of residential records; (v) store the plurality of plumbing system aspects and plurality of residential property aspects in the one or more memories; (vi) generate an estimated remaining lifespan of the plumbing system based upon the plurality of plumbing system aspects and plurality of residential property aspects; (vii) generate a notification, the notification comprising the estimated remaining lifespan of the plumbing system and one or more recommended actions; and/or (viii) present the notification to the user device, such as by transmitting the notification to the user device (if the notification is generated remotely) and/or displaying the notification on the user device to facilitate providing estimated remaining lifespan information and/or associated recommendations to a user. The plumbing life detector device may include additional, less, or alternate functionality, including that discussed elsewhere herein.

For instance, the plumbing life detector device may include at least one or more of: a plumbing material, the plumbing material further comprising: cast iron, pex, pvc, or copper; and/or a plumbing system age, wherein the plumbing system age is indicative of a number of years the plumbing system has been in service. The residential records associated with the address in the geographic location may include temperature data for the geographic location. The plurality of residential property aspects may include: a city water report, the city water report indicating at least one of: a PH level and a water hardness for the address; and/or an age of the residential property. The user input may include a plumbing system indication for the residential property, the plumbing system indication being indicative of: (i) a water softener being present within the residential property; (ii) a water heater age of a water heater present within the residential property; and/or (iii) a past water claim.

The plumbing life detector device may be further configured to, via one or more processors, transceivers, sensors, memory units, and/or other electronic or electric components: (i) generate a lifespan modification factor based upon the one or more recommended actions has on the plumbing system, wherein the lifespan modification factor is indicative of an effect the one or more recommended actions has to the estimated remaining lifespan of the plumbing system; (ii) receive an updated user input from the user, the updated user input indicating that the one or more recommended actions were completed by the user; (iii) generate an updated remaining lifespan based upon the lifespan modification factor and the estimated remaining lifespan; (iv) generate an updated notification, the updated notification comprising the updated remaining lifespan and one or more additional recommended actions; and/or (v) display and/or present the updated notification on or via the user device, such as display the updated notification on a display screen of the user device or present the updated notification via a voice bot.

In another aspect, a computer-implemented method of identifying plumbing issues via one or more local or remote processors, servers, transceivers, sensors and memory units in combination with or separately from other electronic or electrical components or devices may be provided. The computer-implemented method may include (i) collecting, generating, receiving, and/or retrieving historical sensor data from one or more sensors, the historical sensor data including at least: photo data, video data, audio data, smart home data, smart vehicle data, and mobile device data; (ii) feeding the historical sensor data into a machine learning and/or generative artificial intelligence model to train the machine learning and/or generative artificial intelligence model to: (a) identify a current plumbing or a current piping issue; and/or (b) predict a future plumbing or a future piping issue; (iii) retrieving from a memory (or otherwise receiving) via one or more sensors and processors new plumbing and/or new piping sensor data; (iv) inputting the new plumbing or the new piping sensor data into the machine learning and/or generative artificial intelligence model; (v) identifying one or more current and/or future plumbing or piping issues with a building's piping system; (vi) generating one or more corrective actions intending to mitigate and/or prevent damage caused by the current and/or future plumbing issues; (vii) generating a message configured to be displayed on a mobile device (either locally or remotely to the mobile device); and/or (viii) transmitting the message to the mobile device, the message comprising one or more corrective actions for at least one of the following: one or more current plumbing issues, one or more current piping issues, the future plumbing issue, and/or the future piping issue, and/or otherwise presenting the message via the mobile device, such as via a display screen of the mobile device or a voice assistant of the mobile device. The method may include additional, less, or alternate functionality, including that discussed elsewhere herein.

For instance, a residential address or commercial address may be associated with the building or a home. The new plumbing or new piping sensor data may be retrieved from the memory via one or more home-mounted sensors and processors. The new plumbing and/or new piping sensor data may be transmitted to the memory in real time by the one or more sensors or processors. The one or more corrective actions may include a mitigating action and/or a preventative action may be intended to reduce or prevent damage to the home, building, or appliances, such as repairing a toilet, piping, sump pump, or a valve; replacing or repairing appliances (refrigerators, clothes washers, dish washers, etc.); flushing water heaters; etc.

### Exemplary Machine Learning and Generative AI

As discussed elsewhere, some embodiments may utilize machine learning, generative artificial intelligence, or other advanced computing techniques. As such, in some embodiments, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot and/or a ChatGPT-based bot. The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, and/or other such generative model may generate audible or verbal output, text or textual output, visual or graphical output, output for use with speakers and/or display screens of a mobile computing device, and/or other types of output for user and/or other computer or bot consumption.

Noted above, in some embodiments, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In various embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain embodiments, the chatbot ML module may be used in conjunction with the machine vision, image recognition, object identification, AR glasses, VR headsets, other input/output devices, and/or other image processing techniques discussed below. Additionally or alternatively, in some embodiments, the chatbot ML module may be configured and/or trained to implement one or more aspects of the machine vision, image recognition, objection identification, and/or other image processing techniques discussed below.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. In some embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions can be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

1. A computer-implemented method for evaluating aspects of a plumbing system of a residential property using at least one processor in communication with at least one memory device, the computer-implemented method comprising:
receiving, via a user device, a first user input indicative of an address for the residential property;
communicating the address to an external database, the external database containing a plurality of residential records associated with the address in a geographic location;
receiving, via the plurality of residential records, a plurality of plumbing system aspects and a plurality of residential property aspects;
predicting an estimated remaining lifespan of the plumbing system based upon the plurality of plumbing system aspects and the plurality of residential property aspects;
generating a first notification, the first notification comprising the estimated remaining lifespan of the plumbing system and one or more recommended actions;
receiving a second user input indicating the user has implemented the one or more recommended actions; and
generating and transmitting, to the user device for display, a second notification comprising an updated estimated remaining lifespan of the plumbing system, the updated estimated remaining lifespan indicative of an effect the one or more recommended actions has on the estimated remaining lifespan of the plumbing system.

2. The computer-implemented method of claim 1, wherein the at least one memory device is of the user device, and wherein the computer-implemented method further comprises:
displaying the first notification on the user device to facilitate providing estimated remaining lifespan information and the one or more recommended actions to a user.

3. The computer-implemented method of claim 1, wherein the plurality of plumbing system aspects includes at least one of:
a plumbing material, the plumbing material further comprising cast iron, cross-linked polyethylene (PEX), polyvinyl chloride (PVC), or copper; and
a plumbing system age, wherein the plumbing system age is indicative of a number of years the plumbing system has been in service.

4. The computer-implemented method of claim 1, wherein the plurality of residential records associated with the address in the geographic location include temperature data for the geographic location.

5. The computer-implemented method of claim 1, wherein the plurality of residential property aspects comprises:
a city water report, the city water report indicating at least one of a potential of hydrogen (pH) level and a water hardness measure of water provided to the address; and
an age of the residential property.

6. The computer-implemented method of claim 1, wherein the first user input further comprises a plumbing system indication for the residential property, the plumbing system indication being indicative of:
a water softener being present within the residential property;
a water heater age of a water heater present within the residential property; or
a past water claim associated with the residential property.

7. The computer-implemented method of claim 1, further comprising:
generating a lifespan modification factor based upon the one or more recommended actions, wherein the lifespan modification factor is indicative of the effect the one or more recommended actions has on the estimated remaining lifespan of the plumbing system;
wherein the updated estimated remaining lifespan of the plumbing system is based upon the lifespan modification factor and the estimated remaining lifespan; and
wherein the second notification comprises the updated estimated remaining lifespan and one or more additional recommended actions.

8. A plumbing life detector device for evaluating aspects of a plumbing system of a residential property, comprising:
one or more processors and one or more memories comprising executable instructions that, when executed by the one or more processors, cause the one or more processors to:
receive a first user input from a user device indicative of an address for the residential property;
send the address to an external database, the external database containing a plurality of residential records associated with the address in a geographic location;
receive, the plurality of residential records, the plurality of residential records comprising a plurality of plumbing system aspects and a plurality of residential property aspects associated with the address;
extract the plurality of plumbing system aspects and the plurality of residential property aspects from the plurality of residential records;
store the plurality of plumbing system aspects and the plurality of residential property aspects in the one or more memories;
generate an estimated remaining lifespan of the plumbing system based upon the plurality of plumbing system aspects and the plurality of residential property aspects;
generate a first notification, the first notification comprising the estimated remaining lifespan of the plumbing system and one or more recommended actions;
receive a second user input indicating a user has implemented the one or more recommended actions; and
generate and transmit, to the user device for display, a second notification comprising an updated estimated remaining lifespan of the plumbing system, the updated estimated remaining lifespan indicative of an effect the one or more recommended actions has on the estimated remaining lifespan of the plumbing system.

9. The plumbing life detector device of claim 8, wherein the plumbing life detector device is further configured to, via the one or more processors:
transmit the first notification to the user device to facilitate providing estimated remaining lifespan information and the one or more recommended actions to the user.

10. The plumbing life detector device of claim 8, wherein the plurality of plumbing system aspects includes at least one of:
a plumbing material, the plumbing material further comprising cast iron, cross-linked polyethylene (PEX), polyvinyl chloride (PVC), or copper; and
a plumbing system age, wherein the plumbing system age is indicative of a number of years the plumbing system has been in service.

11. The plumbing life detector device of claim 8, wherein the plurality of residential records associated with the address in the geographic location includes temperature data for the geographic location.

12. The plumbing life detector device of claim 8, wherein the plurality of residential property aspects comprises:
a city water report, the city water report indicating at least one of a potential of hydrogen (pH) level and a water hardness measure of water provided to the address; and
an age of the residential property.

13. The plumbing life detector device of claim 8, wherein the first user input further comprises a plumbing system indication for the residential property, the plumbing system indication being indicative of:
a water softener being present within the residential property;
a water heater age of a water heater present within the residential property; or
a past water claim associated with the residential property.

14. The plumbing life detector device of claim 8, wherein the plumbing life detector device is further configured to, via the one or more processors:
generate a lifespan modification factor based upon the one or more recommended actions, wherein the lifespan modification factor is indicative of the effect the one or more recommended actions has on the estimated remaining lifespan of the plumbing system;
wherein the updated estimated remaining lifespan of the plumbing system is based upon the lifespan modification factor and the estimated remaining lifespan; and
wherein the second notification comprises the updated estimated remaining lifespan and one or more additional recommended actions.

15. A computer-implemented method of identifying plumbing issues associated with a plumbing system of a building, the computer-implemented method comprising:
receiving historical sensor data from one or more sensors, the historical sensor data comprising at least one of photo data, video data, audio data, smart home data, or mobile device data;
providing the historical sensor data into a machine learning model to train the machine learning model to:
identify a current plumbing or a current piping issue; and/or
predict a future plumbing or a future piping issue;
receiving, via the one or more sensors, new plumbing data or new piping sensor data;
providing the new plumbing data or the new piping sensor data to the machine learning model;
identifying, via the machine learning model and the new plumbing data or the new piping sensor data, one or more current or future issues with a piping system of the building;
generating, based upon the one or more current or future issues, one or more corrective actions to mitigate or prevent potential damage associated with the one or more identified current or future plumbing issues;
generating a first message configured to be displayed, the first message comprising the one or more corrective actions for at least one of one or more current plumbing issues, one or more current piping issues, one or more future plumbing issues, and/or one or more future piping issues;
receiving a user input indicating a user has implemented the one or more corrective actions; and
generating and transmitting, for display, a second message comprising an estimated remaining lifespan of the piping system, the estimated remaining lifespan indicative of an effect the one or more corrective actions has on the estimated remaining lifespan of the piping system.

16. The computer-implemented method of claim 15, further comprising:
transmitting the first message to a mobile device to present the message via the mobile device, such as via a display screen of the mobile device or a voice assistant of the mobile device.

17. The computer-implemented method of claim 15, wherein a residential address or commercial address is associated with the building.

18. The computer-implemented method of claim 15, wherein the new plumbing data or the new piping sensor data is received from one or more home-mounted sensors and processors.

19. The computer-implemented method of claim 15, wherein the new plumbing data or the new piping sensor data is received in real time from the one or more sensors.

20. The computer-implemented method of claim 15, wherein the one or more corrective actions comprises a mitigating action or a preventative action.
